(19) United States
(12) Patent Application Publication
(10) Pub. No.: US 2016/0241999 A1
(43) Pub. Date: Aug. 18, 2016

(54) CROSS-PLATFORM AUTOMATED PERIMETER ACCESS CONTROL SYSTEM AND METHOD ADOPTING SELECTIVE ADAPTER

(71) Applicant: POLARIS TECH GLOBAL LIMITED, Apia (WS)

(72) Inventors: Ting-Yueh Chin, Taichung (TW); Su-Teng Kuo, New Taipei City (TW); Yuan Wanwen, Dongguan City (CN)

(21) Appl. No.: 15/096,301

(22) Filed: Apr. 12, 2016

Related U.S. Application Data
(63) Continuation-in-part of application No. 14/726,584, filed on May 31, 2015.
Application No. 14/726,584 is a continuation-in-part of application No. 14/623,464, filed on Feb. 16, 2015, now Pat. No. 9,087,246.
Application No. 14/623,464 is a continuation-in-part of application No. 14/953,283, filed on Nov. 27, 2015.

(51) Int. Cl. H04W 4/02; G08C 23/04; H04W 4/00; G07C 9/00; H04B 5/00

(52) U.S. Cl. CPC H04W 4/021; G07C 9/00134; H04B 5/0062; H04W 4/008; G08C 23/04

(57) ABSTRACT

Integrated cross-platform perimeter access control system with a RFID-to-Bluetooth selective adapter configured with a RFID lock, a wireless communication conversion unit configured for operating under a first wireless communication platform and a second wireless communication platform, and a smartphone is disclosed. RFID-to-Bluetooth selective adapter is installed above sensor area of RFID lock to facilitate RFID lock to interrogate the RFID-to-Bluetooth selective adapter. RFID-to-Bluetooth selective adapter equipped with photo sensor unit can be turned on in a contactless manner using smartphone with camera light source. Methods adapted for short-range or long range space/room management automation, transportation vehicle rental management, and automated vehicle parking lot management are included. Low-power infrared proximity sensing circuit of infrared type having an infrared transmitter and receiver unit or of capacitive type having a metal plate can be added to the RFID-to-Bluetooth selective adapter so that the RFID reader can be actuated to perform RFID signal reading.

### CROSS REFERENCE TO RELATED PATENT APPLICATIONS

This continuation-in-part application claims the benefit of U.S. patent application Ser. No. 14/726,584, filed May 31, 2015 currently pending, which in turn, is a continuation-in-part application claiming the benefit of U.S. patent application Ser. No. 14/623,464, which was filed on Feb. 16, 2015, now being U.S. Pat. No. 9,087,246, and this continuation-in-part application also claims the benefit of U.S. patent application Ser. No. 14/953,283, filed Nov. 27, 2015, currently pending, and contents of both of aforementioned patent applications are hereby incorporated by reference in their entirety.

### FIELD OF THE INVENTION

The present invention generally relates to a cross-platform automated perimeter access control system and method, and more particularly, to a cross-platform automated perimeter access control system and method that adopt a selective adapter configured with a wireless communication controlling lock.

### BACKGROUND OF THE INVENTION

In today's automated perimeter access control application scenarios, more and more different industries have jumped on the bandwagon for adapting cost effective automated perimeter access control systems and solutions that have incorporated many of the latest electronic equipment available on the market. For example, some of the industries that have embraced such technology includes the door access control systems with wireless communication controlling doorlocks such as RFID doorlocks, RFID smart door locks and indoor automation and control systems for hospitality industry, vehicle rental industry, and parking space rental facility, just to name a few.

With regards to door access control systems, there are many places that have adopted RFID doorlocks for improved door access control functions. According to a survey of a physical access control market research, more than 70% of the end-users and 80% of industry respondents believe that in the next 3 to 5 years, hope to use mobile phones, key cards, smart label or alternative devices to replace conventional locks and keys. Lock Industry experts have said that the current number of locks sold in China is about 2.2 billion per year or more. In addition, due to privacy and safety concerns at certain establishments, the door locks are periodically replaced by new ones, such as for example, guest room door locks for hotel rooms; as a result, traditional door locks have higher maintenance expense than smart locks.

However, the conventional smart door locks are typically in the form of RFID doorlocks or Bluetooth activated smart doorlocks. If someone already has a RFID doorlock, it would not be possible to easily upgrade the existing RFID doorlock to that of a Bluetooth smart doorlock. In other words, the existing RFID doorlock has to be completed removed, while replaced by a new Bluetooth smart doorlock installed on the door (for replacing the previous RFID doorlock altogether). Meanwhile, after installation of the new Bluetooth smart doorlock, the previous RFID tags being used as keys for opening the previous RFID doorlock can no longer work on the new Bluetooth smart doorlock, so that the new Bluetooth smart doorlock must be limited to be activated only by Bluetooth capable mobile devices. In other words, conventional wireless transmission technologies each has its own adapted usage scenarios, for example, ANT and Bluetooth Low Energy (BLE) typically are used in electronic wearable devices, RFID are typically used in storage, door access control, and electronic wallet applications, infrared are used in conventional remote controllers, and smartphones are adapting Near Field Communication (NFC). However, these wireless platforms or communication standards are not mutually compatible, thus leading to poor or inconvenient cross-platform or cross-protocol adaptations. In particular, satisfying of requirements for full-scale adaptations in electronic payment control management system is difficult to accomplish when switching between different wireless communication protocols/platforms.

Therefore, there is a need in providing a more integrated perimeter access control solution that would be flexible enough to provide effective access control to be operating under multiple wireless communication platforms at the same time, thereby improving the overall perimeter access control needs for users.

Meanwhile, in the hospitality industry, such as hotels, motels, bed and breakfast, resort condos, and Airbnb® lodgings etc, the use of RFID smart door locks and indoor automation and control systems for performing various electrical controls and monitoring are in high demand in recent years, due to the fact that both of the smart door lock and the automation and control system adds to the convenience and enhancement for the overall stay experience of the rented room by the room occupant. For example, a hotel room is typically equipped with power outlets or electrical outlets, HVAC (heating, ventilating, and air conditioning) systems with electrical connections typically operating in one or more electrical circuits, lights that are typically come in two forms, namely, pre-wired lighting fixtures that runs on one or more circuitry with independent power on/off control switches, and independently detachable or moveable lighting fixtures that have electrical plugs plugged into power outlets inside the room for independent power provisioning and on/off control. Other automation and control systems such as for audio/video units, window curtain and blinds opening and closing, security system, dimmer for all lighting, etc can also be incorporated (especially for more luxury or 5-star level of hospitality accommodation establishment). As a result, the room occupant typically finds it to be an enjoyable and delighted experience to be able to conveniently control and automate different room settings and functionalities using just a smartphone.

Therefore, there is also a need in providing a more integrated automation and control solution for the hospitality industry that would be applicable to a rental unit with a RFID door lock installed, and to be able to provide cross-platform control capability under different wireless communication platforms, along with improved overall door access control functionality, and improved convenience and enhancement of the overall stay experience of the room unit by the room occupants.

In addition, in the vehicle rental industry, a vehicle renter typically arrives at a service front desk to perform check-in procedures, sign the service agreement as well as to pay for the vehicle rental service, while the vehicle rental company personnel bring the rental vehicle along with the (physical) keys thereof directly to be handing off to the vehicle renter. Based on the above procedure for vehicle rental, the vehicle rental business spend consideration amount of manpower and effort to provide end-to-end service offering to each vehicle renter, and the entire vehicle rental process is not a convenient and satisfying experience for the vehicle renter because of the excessive time-consuming tedious steps involved, In Taipei, Taiwan, U-Bike™ (also known as YouBike™) managed by the Taipei city municipal government adopts and utilizes an RFID card called EasyCard to be used both as a key/authentication device and electronic wallet for electronic payment. Electronic cash or value can also be added to each EasyCard through interaction with additional value-adding electronic equipment. Meanwhile, the EasyCard is a passive electronic module, which cannot access or retrieve real-time rental system data, and cannot adopt safer methods for conduct electronic payment handling operations, such as tabulating rental duration and service charges rendered. As a result, the use of the EasyCard for YouBike™ is not as convenient as can be.

Another perimeter access control adoption example is at the parking space rental facility, which typically has a sign at the front entrance thereof for showing number of remaining available car parking spaces to potential car parking customers. There is no existing method that transmit real-time remaining car parking space availability information to potential car parking customers, nor is there any available service to reserve a parking spot for a short time period. As a result, a potential car parking customer has to circle around or wait outside a full parking lot (without any vacancy) for an extended period of time without finding any open parking space, thereby wasting a lot of time and gasoline. Meanwhile, the conventional automated parking payment management system typically requires the car parking customer to go to a automated parking ticket payment terminal for processing parking payment by obtaining a payment certificate (or can be called a ticket), and upon obtaining a payment certificate (ticket) such as in the form of a magnetic strip, a smart card, or a smart token, etc, the parking customer then needs to process automated payment for the parking ticket using the automated parking ticket payment terminal. Later upon settling the outstanding balance/bill on the parking ticket, the parking customer can then drive his car near an automated payment certificate/ticket reader, which is located adjacent to an automated exit gate, and upon gaining exit privilege via some processing procedure using the automated payment/ticket reader, the parking customer can then finally drive through the automated exit gate upon raising of a barrier bar of the automated exit gate. As one can see, the entire automated parking payment management system can be quite expensive to own and operate, while may be lacking in providing customer service satisfaction based on new consumer habits.

### SUMMARY OF THE INVENTION

One purpose of the present application is to provide an integrated cross-platform payment control management system that achieves higher level of security and convenience for improved overall user experience by linking or tie together more than one communication protocol/technology/platform, such as RFID, GSM, ANT, NFC, etc. . . .

Another purpose of the present application is to provide added functionalities beyond those offered by conventional electronic doorlock, such as, for example, electronic payment handling as provided by smartlock, allowing an user to obtain a digital certificate over internet as an accepted payment option for the electronic doorlock, while still preserving the ability of opening and closing the electronic doorlock, so to be able to arrive at a front door of a room, and through activation of a RFID transponder along with an authenticated digital certificate to be able to successfully open the RFID doorlock in an efficient manner without hassle. Various types of perimeter access control scenarios can be adapted to implement the above system and method, such as public rental bicycle, i.e. U-Bike in Taipei, Taiwan, and parking space rental facility.

Another purpose of the present application is to provide diversified cross-platform perimeter access control system and method capable of handling two different wireless communication technologies for short-range and long-range usage adoptions such as for space management, transportation rental management, and parking space rental management.

To achieve at least one of the purposes, a wireless communication conversion unit to be used in the cross-platform perimeter access control system and method adopts a first wireless system on chip (SoC) or a first micro-controller unit (MCU) to control an activation or power on/off of a second wireless system on chip (SoC), thereby achieving compatibility among different wireless communication technologies used in the same cross-platform perimeter access control system and method according to an embodiment of present application. Upon receiving of a corresponding wireless transmission signal by the first wireless system on chip, the first wireless system on chip activates an on/off switch to an on position, which then actuates the second wireless SoC. Upon activation of the second wireless SoC, a designated signal contained in the corresponding wireless transmission signal is received to thereby initiating the first wireless SoC to perform a predefined procedure, and upon completion of the predefined procedure, the first wireless SoC can selectively determine as to whether to allow the second wireless SoC to transmit corresponding signals, thereby controlling the interaction between different wireless communication technologies. The first wireless communication platform is different from the second wireless communication platform, and are selected from the group consisting of WIFI, BLE, Bluetooth, 3G, 4G, NFC, RFID, GSM, ANT, LTE, UWB, and Zigbee

In one embodiment, the first wireless SoC is a BLE SoC, and the second wireless SoC is a RFID chip.

In one embodiment, the designated signal includes an interrogating signal, the predefined procedure includes digital certificate authentication procedure.

In one embodiment, the second wireless SoC would not be activated by the designated signal prior to being actuated by the first wireless SoC, so that ongoing or existing system operations can remain intact, without seeing interference caused by the designated signal.

To achieve at least one of the purposes, the wireless communication conversion system can be adapted for usage in a smart doorlock entry system, and/or an automated payment processing system, in which an electronic payment and control system includes a short-range and a long-range smart space management system, a transportation vehicle rental management system, and a parking lot management system, respectively.

The present application describe embodiments of a selective adapter which can be, for example, a RFID-to-Bluetooth selective adapter as described and taught in U.S. Pat. No. 9,087,246, of issued date Jul. 21, 2015, and in U.S. application Ser. No. 14/726,584, filed on May 31, 2015, and in U.S. application Ser. No. 14/726,581, filed on May 31, 2015, for upgrading a conventional RFID lock to become capable of operating in various wireless modes or platforms simultaneously, including, for example RFID or Bluetooth mode, for allowing entry access by using conventional RFID key tags or smartphones and mobile wearable electronic devices, respectively.

In addition, the present invention discloses the selective adapter which functions as a bridge or interface device between a second wireless communication reader equipped device, such as a RFID reader equipped device, and wireless mobile electronic devices operating under a first wireless communication (platform), such as Bluetooth or Bluetooth smart.

The selective adapter of present invention can allow RFID reader equipped devices that are capable of only being activated by RFID tags to be adapted for usage under Bluetooth wireless communication protocol by Bluetooth equipped wireless mobile electronic devices.

The selective adapter of present invention does not negatively affect the original RFID doorlock functionalities between the RFID reader equipped device and the conventional RFID tags, but at the same time, allows for the added or extended capability of operating as well under Bluetooth environment.

The selective adapter of present invention can operate under a Bluetooth protocol version called Bluetooth Low Energy (BLE). The communication data in the form of packets transmitted via BLE or Bluetooth smart protocol are encrypted thus ensuring high level of security.

The selective adapter of present invention can be adapted and configured for usage alongside existing RFID reader equipped devices, such as a RFID lock, for providing Bluetooth capability, so that smartphones and wearable wireless devices can also perform functions similar to that of the RFID tags (RFID transponder) for activating the RFID reader equipped devices, such as a RFID lock.

Upon installation of the selective adapter on or above the sensor area of the RFID lock, a smartphone can be used to activate or lock/unlock the RFID lock.

By using the selective adapter of present invention, the conventional second wireless communication controlling lock functionalities, such as RFID lock functionalities, can still be maintained, and at the same time, further providing added first wireless communication (platform) capability, such as Bluetooth capability.

In embodiments of present invention, an APP is configured to provide wireless smart lock remote control operations, and to provide with a user account for the user on the smartphone to register the selective adapter as an authenticated trusted device in a cloud based authentication server.

In embodiments of present invention, the selective adapter is to be directly attached or disposed at close proximity to a sensor area of the second wireless communication reader, i.e. a RFID reader, of the second wireless communication controlling lock, i.e. a RFID lock.

In embodiments of present invention, the APP is used to set up access rights and permissions for the authenticated RFID-to-Bluetooth selective adapter, the cloud based authentication server can issue a digital certificate to the smartphone to be transmitted to the RFID-to-Bluetooth selective adapter, or the digital certificate can be issued instead through a third party trusted certificate authority. Thus, the APP is configured to provide wireless access management and control of the RFID lock using the RFID-to-Bluetooth selective adapter via wireless communications.

A RFID tag or a RFID card described herein can also be called a RFID transponder.

The present invention provides an integrated short range and long-range automation and control system for perimeter access applications using a RFID-to-Bluetooth selective adapter.

The present invention provides the short range to be operating without internet connection, while the long-range can be operating under internet connection. The short-range automation and control can also be called near-range automation and control (without using internet connection), and the long-range automation and control can also be called distant-range or far-range automation and control (requiring to have internet connection).

The present invention provides the RFID-to-Bluetooth selective adapter to include capabilities that allow an administrator to remotely control the RFID lock, obtain historical data for event logs of people into a perimeter access-controlled space, and to provide automated provisioning and controlling of power on, power off, and electrical power usage history recording functions.

The present invention provides a gateway device that is configured to have internet connection capability, for allowing users to remotely unlock or lock a smart lock using the gateway device, send notifications of unlock events back to a cloud server, and being able to remotely control electrical or electronic devices in a perimeter access control space under short-range (operating mode) or long-range (operating mode).

The present invention provides three detection methods for determining whether any occupant is located or disposed inside a perimeter access-controlled space/region, and if not, can automatically or manually power off the electrical power supply/input to the perimeter access-controlled space/region.

The present invention provides a current sensor, and through the use of the current sensor installed along the power supply circuit for the perimeter access-controlled space/region, the user can measure and assess electric power consumption rate thereof in real-time.

The present invention provides further enhancements to the automation and control solution for indoor applications for the hospitality industry thereby adding to the convenience and enhancement of the overall stay experience of a room unit by offering a plurality of online services and offline services that can be implemented and activated upon unlocking or locking of the smartlock which are installed on doors using a smartphone or wireless wearable device equipped with various wireless communication capabilities, such as WIFI, 4G, or BLE.

The present invention also provides further enhancements, benefits, and/or advantages to the automation and control solution for indoor applications in various other usage scenarios, such as for personal homes, public facilities, and commercial office buildings. Because doors are typically main access points to various confined regions, such as a personal home, a library, a hotel room, etc, thus by controlling the locking and unlocking of the smart door lock of the doors, automation and control of online and/or offline services are thereby also achieved. Such online or offline services can be, for example, a parent can know in real-time that a particular child has come back home safely, or that the hotel management or personnel can know whether or not a guest has entered the rented room; upon entry of a main entrance door (equipped with the smart doorlock and the RFID-to-Bluetooth selective adapter) for a condominium complex, the resident through the unlocking of the smart door lock can gain access to the latest up-to-date information broadcast for residents of the condominium complex, or receive notification of monthly condo fee that is due, etc. Upon entering a room, the occupant can conveniently turn on or turn off electrical power to any connected electrical or electronic devices, such as lamps, lights, air conditioning unit, heater, radio, stereo, television, wall outlet, power outlet, etc, as well as enabling capability for viewing of a readily instantly available display control panel on the smartphone that is automated to perform remote control of the powered up or powered off electrical or electronic devices, without having to find each of the corresponding power switches and remote controls for performing the same control step. Upon the occupant entering into the confined space/room via the unlocking of the smart door lock, the power consumption rate data can be collected under the responsibility or assignment of the occupant, so that the administrator or property manager/owner can charge or assess discounts based on actual power consumption amount of that occupant. Upon exiting the room by locking the smart door lock, the APP can query the occupant as to whether or not it is necessary to turn off all remaining powered on electrical or electronic devices inside the room or the confined region, thereby achieving energy savings.

According to an aspect of the present invention, upon entry of a hotel room or a unit for any hospitality accommodation establishments that is installed with an energy saving key card holder, the energy saving key card holder requires a properly authenticated card to be inserted therein so as to allow provisioning of electrical power to the respective connected units. The use of the RFID-to-Bluetooth selective adapter of present invention together with the smartphone, can thereby eliminate the need of inserting of the key card into the energy saving key card holder for allowing continued power on of electrical or electronic devices while the occupant is inside the room.

According to one embodiment of present invention, the conventional energy saving key card holder can then be modified to allow control by a gateway device, and the energy saving key card holder can be replaced by a relay controller. Unlike the conventional activating signal which is achieved by an insertion of a properly authenticated key card into the energy saving key card holder, the gateway device of present invention performs the same function in lieu thereof. The gateway device and the relay controller can be coupled together in a wired or wireless manner. For rooms or suite units (comprising of multiple number of rooms) that are difficult to have electrical or cable wiring installed, wireless connection between the gateway device and the relay controller can be an effective solution without excess modification required.

According to one aspect of the present invention, three detection methods are provided for determining whether any occupant is located or disposed inside a confined space or room as follow: First detection method: the gateway device continuously broadcast beacon signals, and upon not detecting any reply beacon signal from the smartphone of the occupant, then the occupant is assessed as being possibly departing or left the confined region. At this time, the APP can launch a query to the occupant to ask if he/she is still within the confined region, and also whether or not turn off all electrical connections to save power, and if so, transmitting the power off signal to the gateway device via internet connection. Second detection method: the RFID-to-bluetooth selective adapter is configured with a g-sensor or a vibration sensor therein for detecting door opening, such as for example, if the door opening motion is detected while the switch on the RFID-to-bluetooth selective adapter is not being depressed/pressed, then the occupant is reasoned to have been exiting or left the room. Third detection method: by installing an occupancy sensor as taught in http://en.wikipedia.org/wiki/Occupancy_sensor so as to be detecting occupancy of a space by an occupant thereof, and upon not detecting any reflected signal changes, thereby automatically turning off the electrical devices.

According to another aspect of the present invention, the internet connection capabilities of the gateway device includes the following: a. One or more of WiFi, 3G/4G, Long Range (LoRa), Ultra Narrow Band (UNB) wireless communication protocols can be adopted for performing and handling the internet connection; b. if WiFi is already present within the confined region/room, the gateway device can directly be connected to the WiFi and WiFi access points (AP) to achieve internet connection capability; c. if WiFi is not already present within the confined region, the gateway device can be connected to nearby base station via a 3G/4G baseband transmission module to achieve internet connection capability; d. because the data transmission rate of the gateway device itself is relatively low, it is more cost effective to utilize LoRa or UNB wireless communication technologies. The LoRa and UNB is a physical transmission layer (100 bps-5 k bps) with a low baud rate, and can be transmitted under low power consumption. The transmission distance under line-of-sight condition can reach several kilometers. Just one LoRa or UNB access point needs to be installed or disposed within the confined space for providing space management applications or utilities; i.e. when the gateway device is not able to connect to internet, the short-range control and automation functionalities including door opening, power provisioning, power off of electrical outlet can still maintain normal operation, just that the long-range control and automation functionalities would be not be activated or operating.

According to another aspect of the present invention, short range or long-range/power on/off management and control (including turning power on and turning power off) of electrical or electronic device disposed in a perimeter access-control region can be achieved and provided, even in real-time.

According to another aspect of the present invention, users or occupants can use smartphones or wearable devices' wireless communication capability to be connected to the gateway device to issue power on or power off signals to connected electrical devices. As a result, users or occupants can remotely control the power on and power off (power on/off management) using the long-range control method via internet connection, which can be performed wirelessly to transmit the control packet through the WiFi access point to the gateway device, which then issue the control command.

To achieve at least one of the purposes, a transportation vehicle rental management system is provided, which includes a vehicle rental management cloud server, a gateway device, a plurality of rental vehicles, an automated vehicle rental terminal, a plurality of RFID-to-Bluetooth selective adapters, and a plurality of RFID locks. The rental vehicle can be a car, a van, a minivan, an SUV, a motorcycle, a bicycle, a boat, a recreational vehicle, a jet ski, but is not limited to these. The RFID lock is a RFID reader equipped device. The RFID-to-Bluetooth selective adapter can be configured together with the RFID lock to be installed on each rental vehicle, such as a rental car. The RFID-to-Bluetooth selective adapter can be configured in a stand-alone or portable manner to be used in conjunction with the RFID lock that is installed on the rental vehicle, such as a rental bicycle. The gateway device provides secure two-way wireless communications between the RFID-to-Bluetooth selective adapter and the vehicle rental management cloud server via internet. The automated vehicle rental terminal is configured to communicate and interact with the RFID-to-Bluetooth selective adapters, and equipped to be connected also with the internet.

In one embodiment, the transportation vehicle rental management system with internet access allows users two-way communication capability so as to be able to enter corresponding check-in or log-in data for conducting authentication and verification, thereby foregoing the hassle for doing face-to-face service counter check-in at the transportation vehicle rental facility or location. In addition, smartphone can be used to retrieve the digital certificate which serves as a car key for the rental vehicle, thereby avoiding the further hassle of physical vehicle pick-up by transportation vehicle rental customer service agent along with the handling and care of the (physical/conventional) car key.

In one embodiment, the RFID-to-Bluetooth selective adapter configured together with the RFID lock of present application can be installed near a car door lock on a rental vehicle, and through authentication of the digital certificate acting as the electronic key, the car door lock can then be opened and closed. In addition, the aforementioned digital certificate can also serve as the ignition key to start or stop an engine of the rental vehicle. As a result, the car door lock becomes a more secured built-in component, thereby preventing criminals or thieves from tampering with the car door lock key hole by increasing the degree of difficulty of lock picking.

In one embodiment, the transportation vehicle includes an automobile, an electric scooter, a moped, or a bicycle.

Using the diversified cross-platform automated perimeter access control system in conjunction with the transportation vehicle rental management system of present application, vehicle rental companies are no longer required to physically hand off or drop off a physical car key to the vehicle renter, while instead, transmit a digital certificate via the internet in a wireless manner to the smartphone or mobile electronic device belonging to the vehicle renter, as well as notifying the vehicle renter as to the pick-up location of the rental vehicle. Upon arriving at the rental vehicle, the vehicle renter can conveniently open the car door as well as activate the ignition switch of the rental vehicle for easy drive off of the rental vehicle to a desired destination.

To achieve at least one of the purposes, an automated bicycle rental system, such as for You-bike/U-Bike in Taipei, can adopt the transportation vehicle rental management system of one embodiment. Based on the widespread adoption of mobile phones, a rental service management method of the U-Bike system can be done with the following sequential steps: first, a bicycle renter registers either using internet web portal online or a rental station kiosk and typing in various requested registration information for verification; second, upon successfully completing registration, a digital certificate (as electronic key) is generated and transferred securely to the smartphone of the bicycle renter; third, the bicycle renter can then directly uses the smartphone to swipe over an automated bicycle terminal and actuate the automated smart lock of the YouBike terminal to unlock and release the renter bicycle, the You-bike. As a result, all of the rental data are also transmitted to the smartphone 1 or the mobile electronic device 1, without using any RFID card, such as EasyCard. In addition, the bicycle renter would no longer be required to top off or add value to the EasyCard.

To achieve at least one of the purposes, a transportation vehicle rental management method is provided, which include the following steps. First step: a vehicle renter registers either using a webpage or a rental station kiosk and typing in requested registration information for gaining usage privileges of a transportation vehicle rental management system. Second step: upon successful registration of the vehicle renter, the vehicle renter places a reservation for a rental order of a selected rental vehicle at a specified rental location. Third step: upon successfully reserving the rental vehicle and placing the rental order for the selected rental vehicle at the specified rental location, credit card processing is performed for a deposit for a rental contract for the rental order, and a digital certificate is generated and transmitted via the internet in a wireless manner to a smartphone or a mobile electronic device belonging to the vehicle renter, as well as notifying the vehicle renter as to the pick-up location of the rental vehicle. Fourth step: Upon arriving at the rental vehicle, the vehicle renter uses the smartphone to communicate directly with a smart door lock (driver door lock) of the renter vehicle, the smart door lock of the renter vehicle includes a RFID-to-Bluetooth selective adapter configured together with a RFID lock installed in the drive car door, to gain authorization upon authentication of the digital certificate to unlock the RFID lock and open the car door as well as activating an ignition switch of the rental vehicle (thus power-on the engine to start) that uses an another RFID-to-Bluetooth selective adapter configured together with another RFID lock located at close proximity to a steering column of the rental vehicle. Fifth step, the vehicle renter then drives the rental vehicle to an exit gate of the rental location. Sixth step, upon arriving at the exit gate, the vehicle renter can use the smartphone or the mobile electronic device through wireless communication which has the authenticated digital certificate to open the barrier bar of the exit gate of the vehicle rental location, by bringing the smartphone or the mobile electronic device within communication range to an automated exit ticket reader located at the exit gate and then safely driving off after gaining exit privilege or permission.

To achieve at least one of the purposes, an automated vehicle parking lot management system is provided, which includes a smartphone or a mobile electronic device, an automated parking ticket payment terminal, an automated exit gate, and an automated ticket reader. The automated ticket reader is located adjacent to the automated exit gate and is configured with a RFID-to-Bluetooth selective adapter configured together with a RFID lock installed therein. The automated exit gate includes a barrier bar, which is lowered for obstructing vehicle passage and raised for releasing vehicle passage. Upon completion of performing electronic payment on the internet using an APP or login on a web portal for the parking lot facility, the smartphone can be further used to communicate with the RFID-to-Bluetooth selective adapter to unlock the RFID lock, which in turn raises the barrier bar of the automated exit gate to allow exit of the rental vehicle.

In the automated vehicle parking lot management system, real-time information related to the parking lot facility can be obtained by each parking customer through internet access, and a potential parking customer may also reserve a parking space for a short duration, i.e. 30 minutes, for added convenience to parking customers.

In the automated vehicle parking lot management system, costs are reduced by avoiding expenditures on consumables such as smart tokens, paper tickets, and/or smart card.

In one embodiment, the digital certificate can be distributed by the automated parking ticket payment terminal, while in another embodiment, the digital certificate can be distributed by a centralized management server, in which the central management server monitors and controls the automated parking ticket payment terminal through a network connection.

In one embodiment, the digital certificate can be a one-time digital certificate, or periodical digital certificate. Through the utilization of the RFID-to-Bluetooth selective adapter configured for use in combination with a RFID lock of the present application as part of the automated vehicle parking lot management system, parking lot vendors or business owners can provide various benefits to parking customers including capability of broadcasting real-time information to the smartphones of parking customers, allowing short-duration parking space reservations for parking customer, parking customer can be requested to enter telephone number of the smartphone into the automated parking ticket payment terminal, a set of digital certificate can be issued from the automated parking ticket payment terminal or the centralized management server, the parking customer can then use the set of digital certificate as the key for gaining permission to exit out of the vehicle parking lot. The overall contribution and benefit of the RFID-to-Bluetooth selective adapter configured for use in combination with a RFID lock to the parking lot vendor or business owner include at least cost reduction and management efficiency improvement. To achieve at least one of the purposes, an automated vehicle parking lot management method is provided, which includes the following steps, but the steps do not have to be in sequential order: Step S1: a parking customer can perform electronic payment on the internet for a parking ticket at a parking lot facility using a smartphone. Step S2: upon completion of performing payment, the smartphone can be used to communicate with the RFID-to-Bluetooth selective adapter unlock the RFID lock, which in turn raises the barrier bar of the automated exit gate to allow exit of the vehicle. Step S3: Real-time information for the parking lot facility can be provided to people through internet access. Step S4: A parking space at the parking lot facility can be reserved for a short duration through internet. Step S5: A digital certificate can be distributed by the automated parking ticket payment terminal or a centralized management server, which serves the same purpose as a conventional paid parking ticket, so as to permitting to exit out of the vehicle parking lot. The digital certificate can be a one-time digital certificate, or periodical digital certificate. Step S6: The centralized management server monitors and controls the automated parking ticket payment terminal through a network connection.

Another object of present application is to provide a method for an end user to turn on the RFID-to-Bluetooth selective adapter in a contactless manner while the end user is using an app communicating with the RFID-to-Bluetooth selective adapter, so as to allow a seamless transition between various tasks for the RFID-to-Bluetooth selective adapter, which is equivalent as an IoT device, or an example of an IoT device.

Another object of present invention is to enable an RFID-to-Bluetooth selective adapter to remain in a power saving off-mode without requiring to proactively broadcasting detection signals to reach nearby wireless devices, but yet still able to be turned on or off remotely or contactless via a mobile phone.

Another object of present invention is to provide a contactless RFID-to-Bluetooth selective adapter power-on system using a mobile phone equipped with a camera light source, a RFID-to-Bluetooth selective adapter, an app configured on the mobile phone for managing communication tasks between the mobile phone and the RFID-to-Bluetooth selective adapter, and a photo sensor unit which includes a photosensitive circuit mounted on the RFID-to-Bluetooth selective adapter

Another object of present invention is to prolong built-in battery life of an RFID-to-Bluetooth selective adapter by turning off the RFID-to-Bluetooth selective adapter during extended non-usage periods.

Another object of present invention is to facilitate the turning on and off of the RFID-to-Bluetooth selective adapter device without necessitating any extra devices or costs associated.

One advantage offered by embodiments of present invention to an end user of an APP on a mobile device is the capability of turning on and/or turning off a RFID-to-Bluetooth selective adapter in a convenient contactless manner.

Another advantage achievable by embodiments of present invention that can be realized is that when the RFID-to-Bluetooth selective adapter, which is installed in harder-to-reach locations up to 2 meters away, can still be turned on or off in a convenient contactless manner by the end user using the mobile phone.

Another advantage achievable by embodiments of present invention is that implementation flexibility is available to a wide range of RFID-to-Bluetooth selective adapter configurations.

### BRIEF DESCRIPTION OF THE DRAWINGS

The present invention will become more readily apparent to those ordinarily skilled in the art after reviewing the following detailed description and accompanying drawings, in which:

FIG. 1 shows a block diagram of a wireless communication conversion unit according to an embodiment of present application.

FIG. 2 shows a block diagram of a dual-mode integrated perimeter access control system in accordance to an illustrative example of the embodiment of present invention.

FIG. 3 shows a block diagram of a dual-mode integrated perimeter access control system based on RFID-to-Bluetooth wireless communication conversion in accordance to an illustrative example of the embodiment of present invention.

FIG. 4 shows a block diagram of a Bluetooth module of embodiments of present application.

FIG. 5 shows a block diagram of a customized RFID transponder of embodiments of present application.

FIG. 6 shows a circuit diagram of an embodiment of a control circuit serving as the on/off switch for the present application.

FIG. 7 shows a flow chart of a first time initial configuration method of the RFID-to-Bluetooth selective adapter according to the embodiment of present application using an APP.

FIG. 8 shows a flow chart of an operating method of the RFID-to-Bluetooth selective adapter according to the embodiment of present application.

FIG. 9 shows a schematic block diagram of a low-power infrared proximity sensing circuit used in the cross-platform automated perimeter access control system according to present application.

FIG. 10 shows a schematic block diagram of a low-power capacitive proximity sensing circuit used in the cross-platform automated perimeter access control system according to present application.

FIG. 11 shows a block diagram of a Bluetooth MAC address, an activation key, and a registration key stored in an EEPROM memory disposed in the Bluetooth module of the RFID-to-Bluetooth selective adapter.

FIG. 12 shows a flow chart of a configuration method of the RFID-to-Bluetooth selective adapter for the second embodiment for a first time initial configuration of the RFID-to-Bluetooth selective adapter using an APP.

FIG. 13 shows a flow chart of an operating method of the RFID-to-Bluetooth selective adapter of the second embodiment.

FIG. 14 shows a simplified block diagram of an accelerometer circuit provided as an optional item for the RFID-to-Bluetooth selective adapter to use as theft deterrent feature.

FIG. 15 shows a block diagram of a short range and long-range automation and control system in accordance to a first embodiment of present invention.

FIG. 16 is a block diagram showing three detection methods for determining whether any occupant is located or disposed inside a confined space/room.

FIG. 17 is a flow chart showing a first time initial configuration method of the RFID-to-Bluetooth selective adapter of the first embodiment using an APP.

FIG. 18 shows a flow chart of an operating method of the RFID-to-Bluetooth selective adapter of the first embodiment.

FIG. 19 shows a flow chart of a short-range operating method for the automation and control system of an embodiment of present invention.

FIG. 20 shows a flow chart of a long-range operating method for the automation and control system of an embodiment of present invention.

FIG. 21 shows a block diagram of a short range automation and control system in accordance to an embodiment of present invention.

FIG. 22 shows a simplified operation process flow schematic of the short range space management automation and control method in accordance to the embodiment of present invention.

FIG. 23 shows a block diagram of a short range space management automation and control system in accordance to another embodiment of present invention.

FIG. 24 shows a simplified operation process flow schematic of the short range space management automation and control method of another embodiment.

FIG. 25 shows a block diagram of a long-range room rental management system in accordance to yet another embodiment of present invention.

FIG. 26 shows a block diagram of a long-range room rental management system in accordance to yet another embodiment of present invention.

FIG. 27 shows a block diagram of a transportation vehicle rental management system according to an illustrative example of the embodiment of present invention.

FIG. 28 shows a flow chart diagram of a transportation vehicle rental management method for the transportation vehicle rental management system.

FIG. 29 shows a schematic diagram of an automated vehicle parking lot management system according to another illustrative example of the embodiment of present application.

FIG. 30 shows a flow chart diagram of an automated vehicle parking lot management method for the automated vehicle parking lot management system.

### DETAILED DESCRIPTION OF PREFERRED EMBODIMENTS

The present invention will now be described more specifically with reference to the following embodiments. It is to be noted that the following descriptions of the embodiments of this invention are presented herein for purpose of illustration and description only. It is not intended to be exhaustive or to be limited to the precise form disclosed.

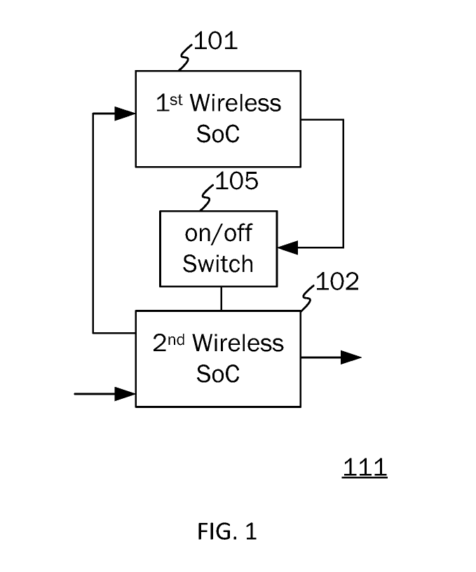

Referring to FIG. 1, a wireless communication conversion unit 111 of an embodiment of present application is shown in a block diagram. The wireless communication conversion unit 111 includes a first wireless system on chip (SoC) 101, an on/off switch 105 and a second wireless system on chip (SoC) 102. The first wireless SoC 101 is coupled to the on/off switch 105, and the on/off switch 105 is coupled to the second wireless SoC 102 to control an activation (on/off) of the second wireless SoC 102 using the first wireless SoC 101, thereby achieving wireless communication conversion between at least two wireless communication technologies (or platforms) according to an embodiment of present application. In the illustrated embodiment, the first wireless system on chip (SoC) 101 can be a BLE SoC, or alternatively, the first wireless SoC 101 can also be a first micro-controller unit (MCU) such as a BLE MCU, while the second wireless SoC 102 can be based on RFID platform to be a RFID chip. Thus, the wireless communication conversion between one wireless communication platform of BLE to another wireless communication platform of RFID can be provided in the illustrated embodiment of FIG. 1. Indeed, the first wireless SoC 101 can be based on one wireless communication technology platform architecture, and the second wireless SoC 102 can be based on a different wireless communication platform architecture. In the illustrated embodiment, upon receiving of a corresponding wireless transmission signal by the first wireless system on chip 101, the first wireless system on chip 101 activates the on/off switch to an on-position, which then actuates the second wireless SoC 102. Upon activation/actuating of the second wireless SoC 102, a designated signal contained in the corresponding wireless transmission signal is received to thereby initiating the first wireless SoC 101 to perform a predefined procedure, and upon completion of the predefined procedure, the first wireless SoC 101 can selectively determine whether to allow the second wireless SoC 102 to transmit the corresponding wireless transmission signal, thereby achieving the wireless communication conversion to control the conversion of a wireless transmission signal received under one wireless platform to turn on or turn off the wireless SoC operating under a different wireless platform as to be able to extend scope of wireless communication coverage and offering adaptability and flexibility to more than one wireless communication platform operation at each given time. In the illustrated embodiment, the designated signal can be an interrogating signal, the predefined procedure includes the digital certificate authentication procedure. In addition, the second wireless SoC 102, prior to being activated or actuated by the first wireless SoC 101, will not actuated by the designated signals transmitted from other RFID tags/transponder within the same RFID (wireless) platform when being used in tandem with a RFID lock 20.

It is worthy to point out that the wireless communication conversion unit 111 of the embodiment can be adapted for use in other types of wireless communication technologies as well, depending upon needs and availability of the user, such as, for example, BLE can be converted to RFID, IrDA can be converted to RFID, or RFID can be converted to BLE, but is not limited to just these examples for the wireless communication conversion unit 111. In addition, the wireless communication conversion unit 111. The wireless communication conversion unit 111 can be realized and formed in an integrated device within a SoC, so as to form a wireless communication conversion device (not shown) belonging to an integrated perimeter access control system, which comprises the wireless communication conversion device configured for receiving a wireless transmission signal and operating under a first wireless communication platform and a second wireless communication platform.

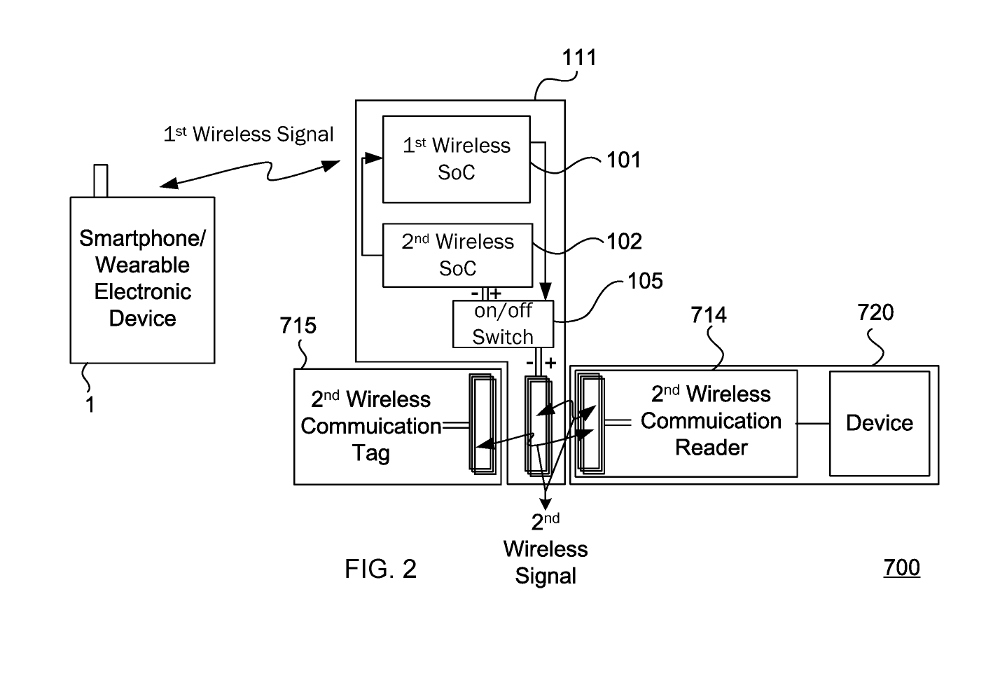

As shown in FIG. 2, an integrated perimeter access control system 700 is provided according to an illustrative general example of the embodiment of present invention. The (cross-platform) integrated perimeter access control system 700 includes a wireless communication conversion unit 111, a smartphone 1 (1^{st} wireless communication equipped mobile electronic device), a 2^{nd} wireless communication tag 715, and an electronic lock 720. The electronic lock 720 can also be referred to as a second wireless communication controlling lock (not shown) herein, since the lock functionalities can be controlled via various wireless communication modules installed therein.

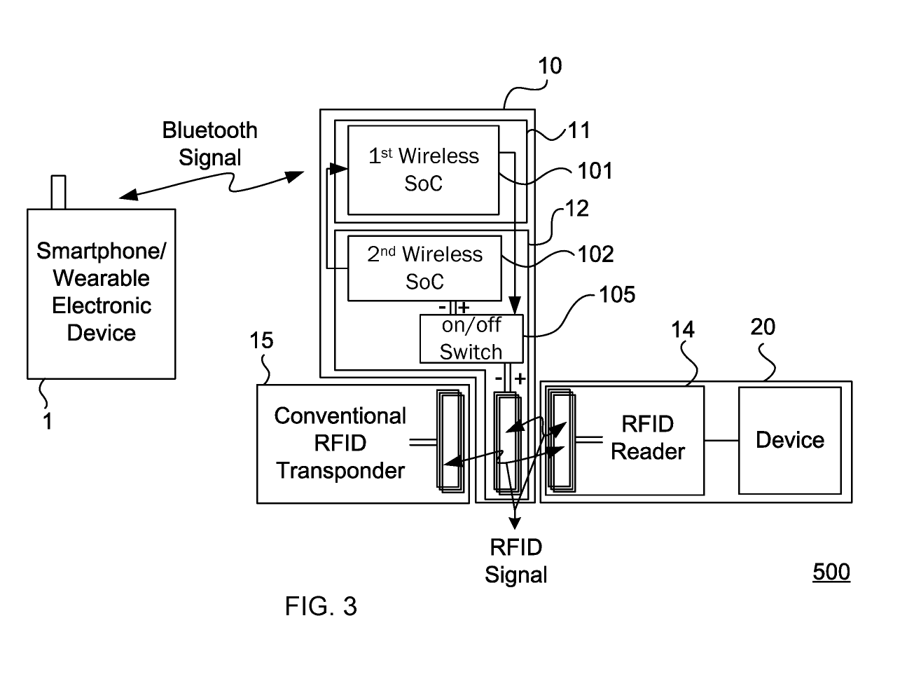

The wireless communication conversion unit 111 in the illustrated embodiment of FIG. 2 can also be considered as being at least a part of a selective adapter 10 as shown in FIG. 3. The wireless communication conversion unit 111 is installed or attached onto the electronic lock 720, which has a 2^{nd} wireless communication reader 714 therein. The electronic lock 720 (or the second wireless communication controlling lock) an be a RFID, NFC, magnetic card, or digital keypad door lock that is mounted to a door, a gate, or a barrier controller. The 1^{st} wireless SoC 101 of the wireless communication conversion unit 111 performs the function of controlling to activate and deactivate the 2^{nd} wireless SoC 102, by directly controlling an on/off switch of the 2^{nd} wireless SoC 102. This on/off switch can be installed at the antenna terminal of the 2^{nd} wireless SoC chip 102. The wireless communication conversion unit 111 as realized in the form of a selective adapter can be configured to selectively determine whether to allow transmission of the wireless transmission signal after performing a digital certificate authentication procedure based on the wireless transmission signal.

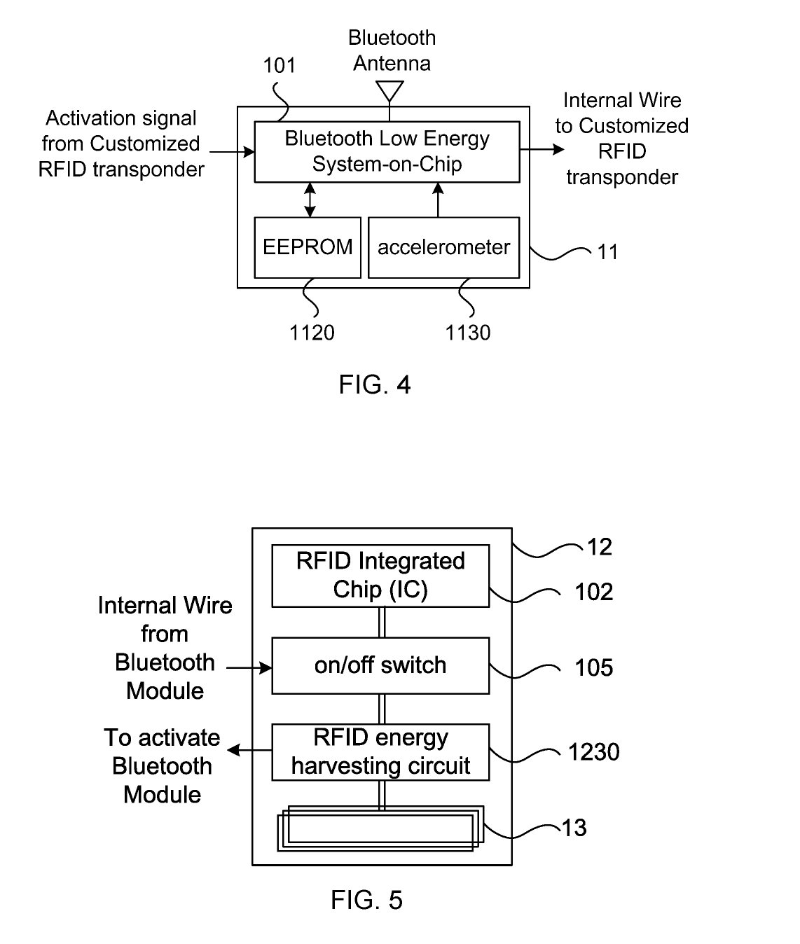

As shown in FIG. 3, an integrated perimeter access control system 500 based on RFID-to-Bluetooth wireless communication conversion is provided according to an illustrative example of the embodiment of present invention. The (cross-platform) integrated perimeter access control system 500 includes a smartphone 1 (a Bluetooth smart equipped wireless mobile electronic device), a RFID-to-Bluetooth selective adapter 10, a conventional RFID tag 15, and a RFID lock 20. A RFID tag 15 or a RFID card described herein can also be called a RFID transponder. The RFID-to-Bluetooth selective adapter 10 is installed or attached onto the RFID lock 20, which has a RFID reader 14 therein. In this embodiment, the RFID lock 20 is a conventional RFID smart card door lock that is mounted to a door. The RFID-to-Bluetooth selective adapter 10 includes a customized RFID transponder 12 and a Bluetooth module 11. The Bluetooth module 11 of the RFID-to-Bluetooth selective adapter 10 performs the function of controlling to activate and deactivate the customized RFID transponder 12, by directly controlling an on/off switch of the customized RFID transponder 12. This on/off switch can be installed at a RFID chip antenna terminal. The RFID-to-Bluetooth selective adapter 10 is just one example of the selective adapter 10 that is provided according to embodiments of present invention. For example, another example for the selective adapter 10 can be a WIFI-to-NFC selective adapter. In addition, yet another example for the selective adapter 10 can be a 4G-to-RFID selective adapter. As shown in FIG. 4, the Bluetooth module 11 includes a Bluetooth Low Energy System-on-Chip (SoC) 101, a memory 1120, and an accelerometer 1130. The accelerometer 1130 can be one axis or three axis accelerometer. The memory 1120 in a preferred embodiment is an EEPROM memory.

As shown in FIG. 5, the customized RFID transponder 12 includes an RFID Integrated chip (IC) 102, a RFID sensor coil 13, an on/off switch 105, and a RFID energy harvesting circuit 1230. The customized RFID transponder 12 is different from the conventional RFID transponder 15 at least in the following: The customized RFID transponder 12 can be directly activated by the Bluetooth module 11 only, as well as, the customized RFID transponder 12 does not become activated based on any interrogating actions of any RFID reader 14 (which a conventional RFID transponder 15 would). In other words, any RFID reader cannot trigger any direct activation of the customized RFID transponder 12 of the RFID-to-Bluetooth selective adapter 10, because the initial activation trigger must come from the Bluetooth module 11 of the RFID-to-Bluetooth selective adapter 10 itself, and not from any outside devices. Thus, the customized RFID transponder 12 without being triggered into activation, would not interfere with other RFID tags/transponder when being used in tandem with the RFID lock 20. The customized RFID transponder 12 is directly activated only by the Bluetooth module 11 and not by the RFID reader 14 of the RFID lock 20 using an internal wire in the Bluetooth module 11 extending out to connect the on/off switch 1220 of the customized RFID transponder 12 for providing the activation. The RFID energy harvesting circuit 1230 detects whether the RFID reader 14 of the RFID lock 20 is in an interrogating state, and upon determining that the RFID reader 14 is in an interrogating state, the RFID energy harvesting circuit 1230 is to awaken the Bluetooth module 11 as to allow the smartphone 1 and the Bluetooth module 11 engage in authentication, and upon authentication thereby activating the customized RFID transponder 12.

There are two methods for providing authentication security between the customized RFID transponder 12 and the RFID reader 14 of the RFID lock 20, in which a first method is to use the identification code of the RFID chip 1210 as the identifying number, while a second method adopts the registration key residing in the memory 1120 of the bluetooth module 11 as the identifying number. The benefit of the first method of using the identification code of the RFID chip 1210 is that implementation can be achieved right at the current existing RFID chip. However, because the identification code of the RFID chip available in the marketplace are made in a permanent manner by one-time programming (OTP), thus would not allow for self-destruction protection technique upon the RFID chip being compromised when taken by criminals or thieves. However, upon adoption of the second method which has the registration key residing in the memory 1120 of the bluetooth module 11 used as the identifying number, and upon the RFID chip 1210 being compromised when taken by criminals or thieves, self-destruction protection technique can be performed to erase the registration key residing in the memory 1120, so that security is enhanced by eliminating the risk of registration key compromise. As a result, the second method is a more secure option; however, the first method offers cost advantage.

The RFID-to-Bluetooth selective adapter 10 is installed directly or indirectly on or above a sensor area of the RFID lock 20, so as to facilitate the RFID Reader 14 in the RFID lock to detect or interrogate the RFID-to-Bluetooth selective adapter 10 properly. Under typical normal operation, the customized RFID transponder 12 disposed inside the RFID-to-Bluetooth selective adapter 10 is not under an active operating mode (dormant mode), thereby allowing the RFID reader 14 of the RFID lock 20 to read and interrogate other RFID tags 15 without any perceived negative effect or detriments due to the presence of the RFID-to-Bluetooth selective adapter 10.

In the illustrated embodiment, the smartphone 1 through BLE can perform authentication, and upon the smartphone 1 successfully being authenticated, the RFID-to-Bluetooth selective adapter 10 can activate/turn on the customized RFID transponder 12 therein for 1-5 seconds to allow the RFID reader 14 of the RFID lock 20 to read a signal from the customized RFID transponder 12 of the RFID-to-Bluetooth selective adapter 10. Upon authentication by the RFID reader 14 of the RFID-to-Bluetooth selective adapter 10 using the customized RFID transponder 12 therein, the RFID lock 20 is then activated. By combining the disclosure and teachings found in U.S. patent application Ser. No. 14/953,283, in which an example of the IoT device can be the RFID-to-Bluetooth selective adapter 10 of instant disclosure, together with the instant disclosure, the following additional features and capabilities are realized for the RFID lock 20. For example, a method for an end user to turn on the RFID-to-Bluetooth selective adapter 10 in a contactless manner while the end user is using an app communicating with the RFID-to-Bluetooth selective adapter 10 is provided, so as to allow a seamless transition between various tasks for the RFID-to-Bluetooth selective adapter 10. The RFID-to-Bluetooth selective adapter 10 can remain in a power saving off-mode without requiring to proactively broadcasting detection signals to reach nearby wireless devices, but yet still able to be turned on or off remotely or contactless via a smartphone 1. A contactless RFID-to-Bluetooth selective adapter 10 power-on system using a smartphone 1 equipped with a camera light source, a RFID-to-Bluetooth selective adapter 10, an app configured on the mobile phone for managing communication tasks between the mobile phone and the RFID-to-Bluetooth selective adapter 10, and a photo sensor unit which includes a photosensitive circuit mounted on the RFID-to-Bluetooth selective adapter 10 is provided. Built-in battery life of an RFID-to-Bluetooth selective adapter 10 is extended or prolonged by turning off the RFID-to-Bluetooth selective adapter 10 during extended non-usage periods. As a result, an end user of an APP on a mobile device can turn on and/or turn off a RFID-to-Bluetooth selective adapter 10 in a convenient contactless manner.

One advantage of the embodiment of present invention of using the RFID-to-Bluetooth selective adapter 10 is that when operating under a turned-off or deactivated state, a RFID sensor coil 13 of the RFID-to-Bluetooth selective adapter 10 is under an open circuit, the RFID lock 20 (or RFID doorlock) can continue on reading and interrogating other conventional RFID tags 15 without any perceived negative effects or detriment when there is no smartphone with Bluetooth communication capability being at close proximity thereof.

Upon completion of authentication of the smartphone 1 by the RFID-to-Bluetooth selective adapter 10, the access rights for the authenticated user is provided, and at this time, the customized RFID transponder 12 and the on/off switch 105 is activated/turned on, so as to allow data to be transmitted and read by the RFID reader 14 of the RFID lock.

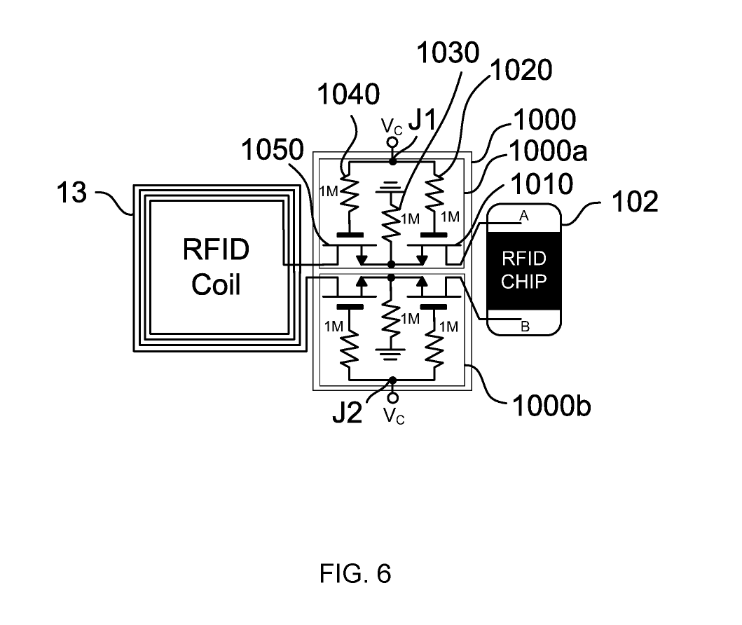

A conventional RFID transponder (such as an RFID card/RFID tag) is typically formed by a RFID coil 13 connecting to a RFID chip 102. Meanwhile, referring to FIG. 6, a circuit diagram of an embodiment of a control circuit serving as the on/off switch for the present application is shown. In the illustrated embodiment, a control circuit 1000 is formed between the RFID coil 13 and the RFID chip 102, and the control circuit 1000 belongs as a part of the RFID-to-Bluetooth selective adapter 10. The control circuit 1000 enables the Bluetooth chip to control a connection state (i.e. open versus closed, connected state versus disconnected state) of the RFID chip 102 and the RFID coil 13, so as to allow sensing by the RFID reader. The control circuit 1000 is formed by four MOSFETs (metal-oxide-semiconductor field-effect transistors), which are used for performing the switching operations of turning on or off. The control circuit 1000 is made of serially coupling two identical circuit portions 1000a, 1000b. In other words, the circuit portion 1000a is identical to the circuit portion 1000b. Referring to the circuit portion 1000a of the control circuit 1000, two N-MOSFETs 1010, 1050 are coupled together in a source-to-source configuration. The N-MOSFETs/nMOSFETs 1010, 1050 are n-type MOSFETs, in which the source/drain and channel types are all n-type. The drain of the nMOSFET 1050 is connect to an end of the RFID coil 1002, the drain of the nMOSFET 1010 is connected to an end of the RFID chip 1001. A resistor 1020 and a resistor 1040 are serially connected to the gates of the nMOSFET 1010, 1050, respectively. Due to the fact that the nMOSFET gate does not conduct current therethrough, the series resistance of the resistor 1020 and the 1040 can be 1 MOhm or higher, respectively. A resistor 1030, as an optional element, can be adopted to provide a reference resistance for the source of the nMOSFET 1010, 1050 coupled to ground, so as to ensure that the DC voltage level of the source of the nMOSFET 1010, 1050 to be at zero volt (V). In the illustrated embodiment, a control voltage (Vc) is used in the circuit portion 1000a, in which the voltage Vc is coupled to the control circuit 1000 at junctions J1 and J2, respectively. When the control voltage is held at 0 volt (turned-off state), both the RFID coil 1002 and the RFID chip 1001 are maintained under open-loop state. In other words, when the control voltage (Vc) is held at 0V, the circuit portion 1000a is at a shut-off state (having the RFID coil 1002 and the RFID chip 1001 are under the open-loop state); meanwhile, when the control voltage (Vc) is changed to 3V, (Vc=VDD), the circuit portion 1000a is then changed to a turned-on state, whereby the RFID chip 1001 is activated. The high-frequency coil is sensitive to parasitic capacitance of the control circuit, therefore in order to avoid a malfunction or false action caused by the coil being unable to be turned off or shut off, a N-MOSFET possessing reduced parasitic capacitance should be selected, with output capacitance usually preferred to be of less than 5 pF. The RFID-to-Bluetooth selective adapter 10 is directly mounted over the sensor area of the RFID reader, with the RFID coil 1002 being held under open circuit state while under normal operating condition, thus would not interfere with the RFID reader sensing functions. During the normal operating state, the control voltage Vc is held at zero volt (0V), and upon authentication and verification of the digital certificate between the smartphone 1 and the Bluetooth device, the control voltage Vc is then changed to 3V for a duration of n seconds, in which n can be 0.5 to 2.

The RFID-to-bluetooth selective adapter 10 is directly installed directly above a sensor area of the RFID reader 14, which has the RFID chip, so as to facilitate the RFID Reader 14 to detect or interrogate the RFID-to-Bluetooth selective adapter 10 properly, which would have the RFID coil 1002 to be under open-loop state under typical operating condition, and thus would not interfere with the sensing operation of the RFID reader 14. In one illustrative example, the control voltage Vc is at 0 volt, but upon the smartphone 1 and the (BLE operating) RFID-to-Bluetooth selective adapter 10 completing of authentication and verification of the digital certificate, the control voltage is changed to 3 volts and held for a number of seconds n. The duration of n can be between 0.5 seconds to 2 seconds. In another embodiment, the resistors R can be 1M Ohm to be coupled to ground, for use to ensure that the direct current voltage level Vs is to be 0V, and is an optional element or component.

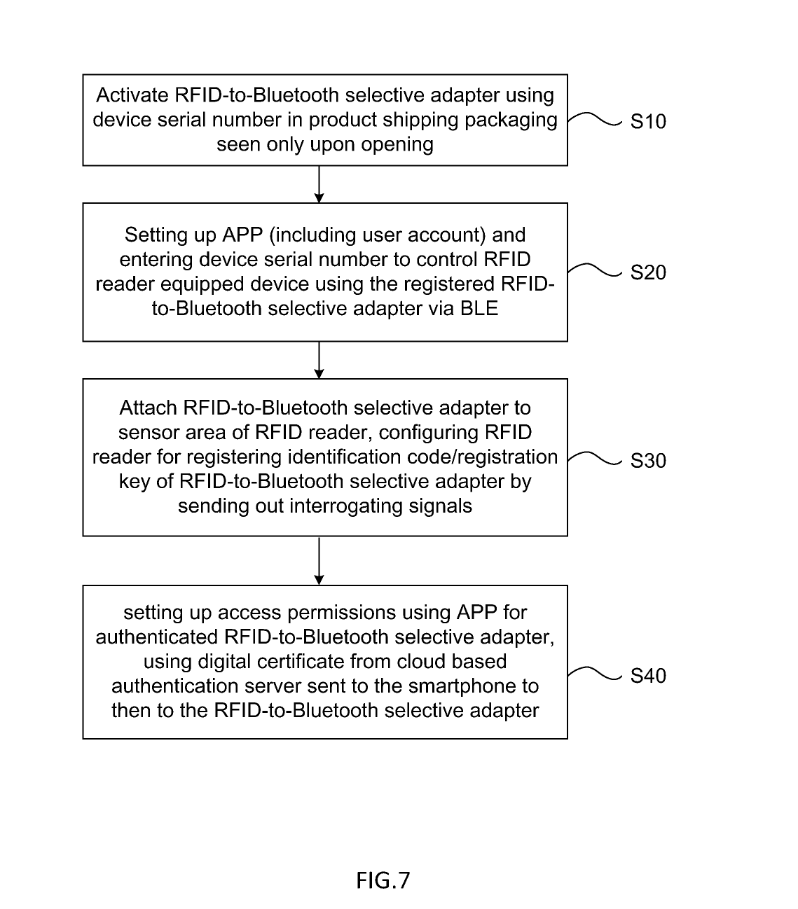

Referring to FIG. 7, a first time initial configuration method of the RFID-to-Bluetooth selective adapter 10 of the embodiment using an APP is described, which include the following steps:

In Step S10, the RFID-to-Bluetooth selective adapter 10 is activated/turned on, to be entering into a setup mode, in which a product shipping packaging of the RFID-to-Bluetooth selective adapter 10 contains a device serial number therein, which can a string of alphanumeric number or a QR code. The device serial number of the RFID-to-Bluetooth selective adapter 10 can only be seen or read upon opening of the shipping packaging to remove the RFID-to-Bluetooth selective adapter 10, so that when sealed, the packaged RFID-to-Bluetooth selective adapter 10 would not reveal the device serial number to any bystander.

In Step S20, a user can go to an APP store to download an APP that is configured to provide wireless access management and control of the RFID lock 20 (or doorlock) using the RFID-to-Bluetooth selective adapter 10 via BLE communications. Upon opening the APP for the first time, a user account is required to be set for the user, and upon successfully setting up the user account on the smartphone 1, the device serial number is entered to register the RFID-to-Bluetooth selective adapter 10 as an authenticated trusted device in a cloud based authentication server.

In Step S30, the RFID-to-Bluetooth selective adapter 10 is to be directly attached or disposed at close proximity to the sensor area of the RFID reader of the RFID lock 20, and to launch or initiate the RFID reader of the RFID lock 20 to enter into a configuration mode for adding a new identification code/registration key of the RFID-to-Bluetooth selective adapter 10. The RFID reader of the RFID lock 20 is to read a signal for an identification code/registration key for the customized RFID transponder of the RFID-to-Bluetooth selective adapter 10 by sending out an interrogating signal to the RFID transponder of the RFID-to-Bluetooth selective adapter 10 so as to perform registering of the identification code/registration key for the RFID-to-Bluetooth selective adapter 10. The identification code/registration key is a hexadecimal ID string of 16 bytes.

In Step S40, the APP is used to set up access rights and permissions for the authenticated RFID-to-Bluetooth selective adapter 10, the cloud based authentication server can issue a digital certificate which is an encrypted digital file to the smartphone 1 to be transmitted to the RFID-to-Bluetooth selective adapter 10, or the digital certificate can be issued instead through a third party trusted certificate authority. This digital certificate can be a perpetual certificate or a timed-duration certificate.

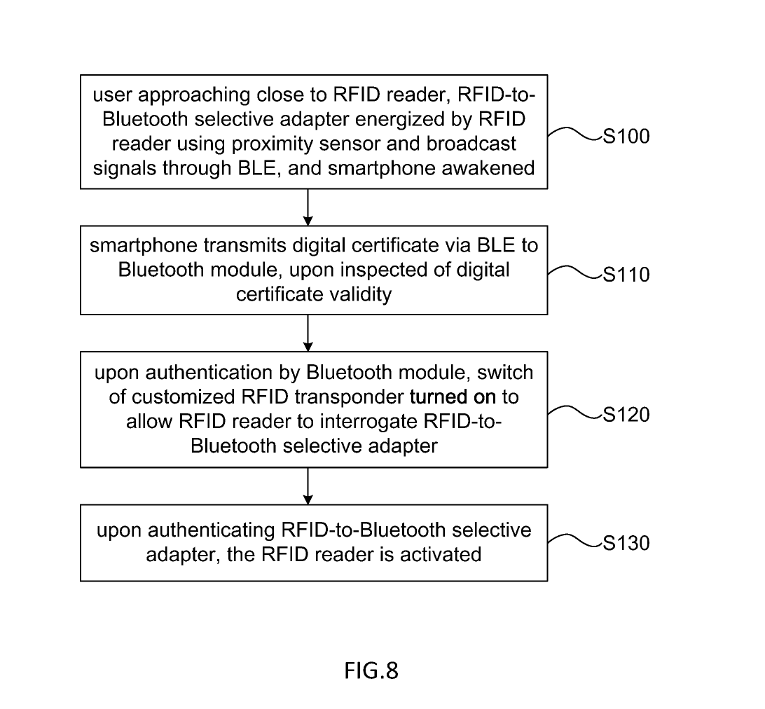

Referring to FIG. 8, an operating method of the RFID-to-Bluetooth selective adapter 10 of the first embodiment is described to include the following steps: In Step S100, when the user is approaching close by or at close proximity to the RFID lock, the RFID-to-Bluetooth selective adapter 10 is energized by the interrogating signals from the RFID reader of the RFID lock (the RFID reader has an inductor coil which broadcast the interrogating signals) when the RFID lock through the use of a proximity sensor, or the like, is able to sense the user located at close proximity thereof, which in turn, will allow the RFID-to-Bluetooth selective adapter 10 to broadcast signals through Bluetooth or BLE, and the smartphone 1 (or any wearable electronic device) in Bluetooth/BLE broadcast coverage range would then intercept the broadcast signal to be automatically awakened and activated.

In Step S110, the smartphone 1 (or the wearable electronic device) transmits the digital certificate to the RFID-to-Bluetooth selective adapter 10 via BLE to the Bluetooth module inside therein, the RFID-to-Bluetooth selective adapter 10 is to inspect as to whether the digital certificate is valid or expired or invalid. Without having any authenticated smartphone 1 or wearable mobile device 1 being properly configured by the smart doorlock remote control APP, or in other words, if the user is not using any smartphone 1 or that the smartphone 1 has yet to be installed with the APP, the user can still use a conventional RFID tag or RFID smart card to be placed on or above the sensor area of the RFID lock for performing proper access control usage (i.e. open or close the door, turn on and turn off the door lock).

In Step S120, upon successful authentication by the Bluetooth module, the on/off switch of the customized RFID transponder inside the RFID-to-Bluetooth selective adapter 10 is turned on, so as allow the RFID reader of the RFID lock to interrogate and read the customized RFID transponder inside the RFID-to-Bluetooth selective adapter 10.

In Step S130, upon successfully verifying or authenticating the ID string for the customized RFID transponder of the RFID-to-Bluetooth selective adapter 10, the RFID lock is activated. The RFID-to-Bluetooth selective adapter 10 can obtain power from an integrated power supply, such as a small battery, or obtain electrical power through energy harvesting using the RFID energy harvesting circuit from the interrogation signals in the form of electromagnetic waves from the RFID reader of the RFID lock 20. For the sake of power conservation, the RFID reader of the RFID lock would not be operating under continuously sensing mode of nearby EMF signals (typically operating under current of dozens of milliamps, mA), only when the RFID reader is placed in close proximity to the user, would then trigger activation of the RFID reader to perform EMF signal sensing by the RFID reader, in this manner, various proximity sensing methods such as by infrared LED, ultrasonic sensing, microwave sensing, which are low-power proximity sensing methods. (requiring current in the tens of microamps, uA) can be used. The energy from the EMF signals of the RFID lock can be used to power on the RFID-to-Bluetooth selective adapter 10, so that Bluetooth or BLE communication from the RFID-to-Bluetooth selective adapter 10 can be established with the adjacent smartphone 1 to perform two way communications using the APP providing wireless access management and control of the RFID lock through the RFID-to-Bluetooth selective adapter 10 downloaded in the smartphone 1. Under typical operation, the power consumption of the RFID-to-Bluetooth selective adapter 10 is about 5 microamps, or 5 uA.

Typically in commercial applications, the conventional doorlocks use batteries as power supply. However, due to the excessive power draw/usage of the RFID sensing procedures, some door locks may optionally install a low-power proximity sensing circuit of reduced power consumption as an added feature for achieving overall power-savings. The low-power proximity sensing circuit is capable of detecting presence of objects at close proximity in front of the sensor area at any given time. The typical sensing distance for the low-power proximity sensing circuit is 1 to 10 cm, such as for example, 5 cm. Upon detecting of presence of an obstructing object within a sensing area by the low-power proximity sensing circuit, a trigger signal is sent out or broadcasted to the RFID reader to actuate the RFID coil to be sensing. The conventional low-power proximity sensors are typically of two types, namely, an infrared (IR)-based and a capacitive-based types of proximity sensors. The infrared-based proximity sensor adopts an operating principle based on detecting reflected infrared signal through emitted infrared pulses periodically so as to identify whether there is an object in front thereof. The capacitive-based proximity sensor adopts an operating principle based on detecting amount of change in capacitance above the sensor area to determine whether there is an object in front. To facilitate seamless and effective integration and adoption of the RFID-to-Bluetooth selective adapter 10 into different conventional RFID lock systems, the low-power proximity sensor unit of the RFID lock 20 can be utilized to work together with the RFID-to-Bluetooth selective adapter 10 for overcoming issue relating to not able to properly activating the RFID lock 20 without placing the RFID card on the sensor area, because during the usage of smartphone 1 by the user in combination with the RFID-to-Bluetooth selective adapter 10 in lieu of placement of a RFID card for activating the RFID lock 20, there is no such RFID card being used alongside. In other words, the low-power proximity sensor unit provides the RFID-to-Bluetooth selective adapter 10 together using a smartphone 1 to have an alternative method for activating the RFID lock 20 without placement of any RFID card on the sensor area. Upon adoption of the lower-power proximity sensing circuit, the RFID smart doorlock power consumption is reduced to tens of microamperes (uA), which often extends the battery life up to a year.

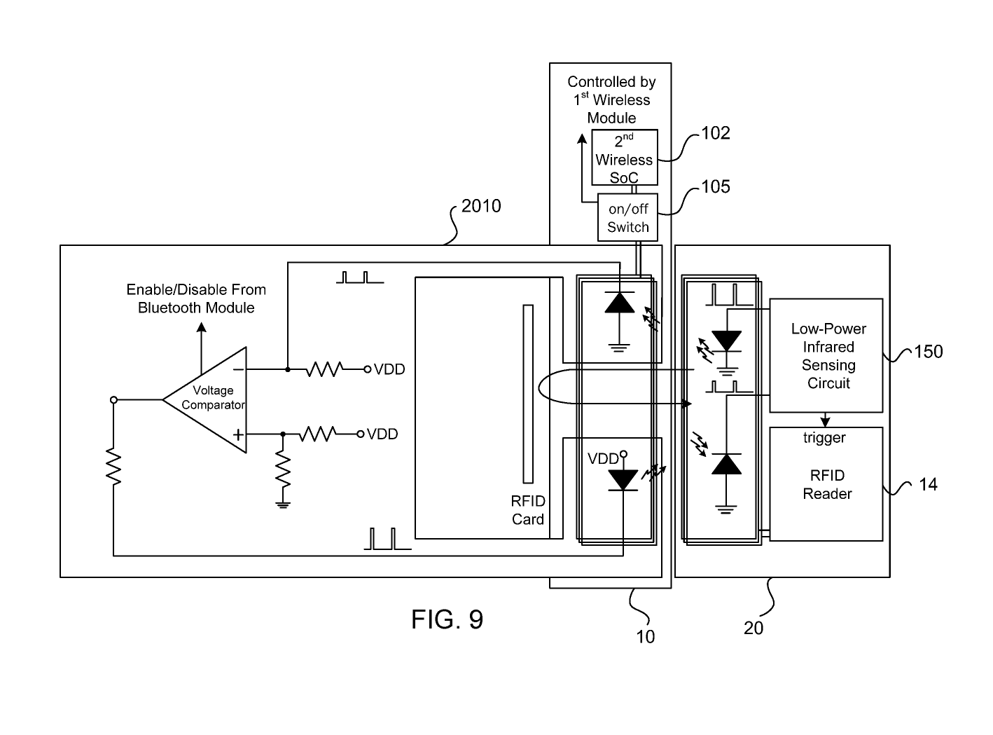

Referring to FIG. 9, a schematic block diagram shows a low-power infrared proximity sensing circuit 150 used in the cross-platform automated perimeter access control system according to present application. The infrared-type proximity sensing circuit is described as follow: For conventional RFID locks, there may be an infrared proximity sensor installed, and upon detecting of presence of an object in the sensor area, such as an RFID card, the infrared proximity sensor unit can then trigger the RFID reader to actuate the RFID coil, for reading the RFID card in front of the sensor area. The low-power infrared proximity sensing circuit 150 as shown in the illustrated embodiment of FIG. 9 has an infrared transmitter and receiver unit 2010 that can be added to the RFID-to-Bluetooth selective adapter 10 in order to solve the problem of activating the conventional RFID lock without placement of any RFID card on the sensor area. The infrared transmitter and receiver unit 2010 performs the following steps: a reflected signal is simulated by the infrared transmitter and receiver unit 2010 and transmitted to the low-power infrared proximity sensor; the infrared receiver of the low-power infrared proximity sensor of the RFID lock 20 receives the (simulated) reflected signal from the infrared transmitter and receiver unit 2010; using a comparator to revert the reflected signal to become a switching on/off signal, and transmitting the switching on/off signal to the infrared receiver of the infrared proximity sensor of the RFID lock 20 from the infrared transmitter and receiver unit 2010. Under normal operating condition, the infrared transmitter and receiver unit 2010 remains dormant or in hibernating mode, the low-power infrared proximity sensor of the RFID lock 20 continuously perform the function of detecting presence of object over the sensor area. It is when the RFID-to-Bluetooth selective adapter 10 is brought into action and usage for opening the RFID lock 20, the voltage comparator circuit is then initiated, and the infrared transmitter and receiver unit 2010 is then triggered into action to perform steps as described above for allowing the RFID lock 20 to conduct RFID coil actuation.

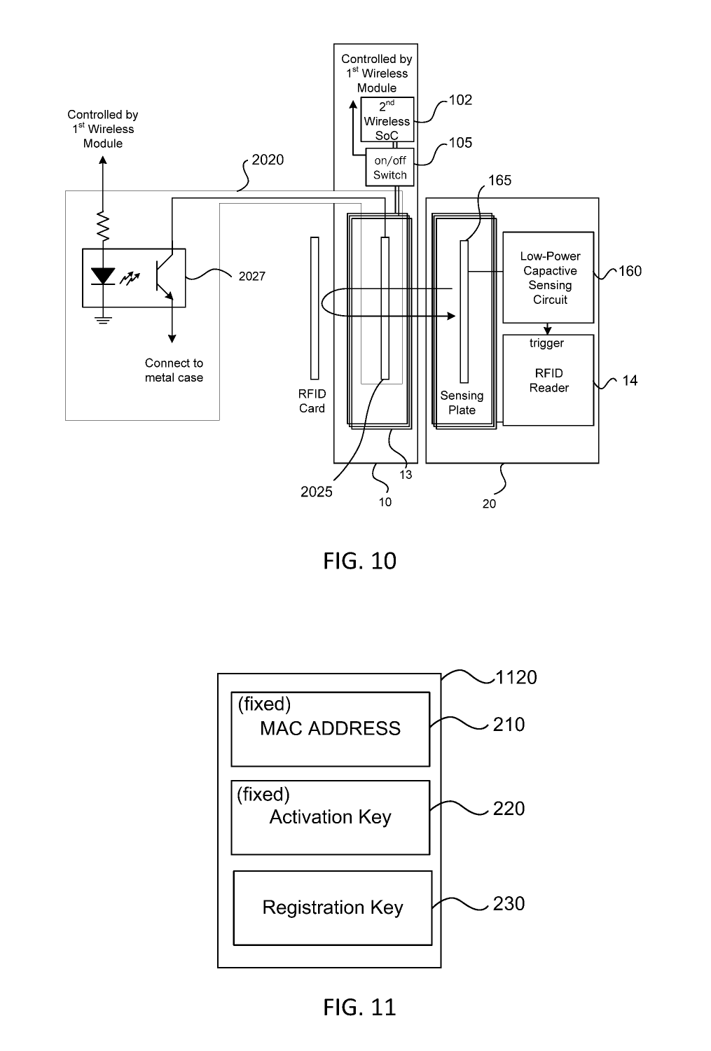

Referring to FIG. 10, a schematic block diagram showing a low-power capacitive proximity sensing circuit 160 used in the cross-platform automated perimeter access control system according to present application. In an implementation example which has the conventional RFID lock 20 equipped with a conventional capacitive-typed proximity sensor, the switchable capacitance plate circuit 160 of this illustrated embodiment is provided, which includes the following additional features: A metal plate 2025 is adhered to the sensing plate 165 of the RFID reader of the RFID lock 20, so that upon activating the RFID-to-Bluetooth selective adapter 10 to initiate the RFID lock opening action, the metal plate 2025 is connected to an output terminal of a photocoupler 2027, and the other output of the photocoupler 2027 is connected to a larger metal object, and thereby more effectively actuating the capacitive proximity sensor of the RFID lock 20. In the illustrated embodiment, the larger metal object can be a metal housing of the RFID lock 20 (a smart doorlock). As a result, upon successfully authentication procedure has been performed between the RFID-to-Bluetooth Selective Adapter 10 and the smartphone 1, apart from having the on/off switch 105 electrically connecting the 2nd wireless soc 102 with the RFID coil 13, the 1^{st} wireless soc 101 is to actuate the photocoupler 2027, thereby allowing the metal plate 2025 to be electrically connecting with the metal housing of RFID lock 20, and the capacitance over the sensor area of the RFID reader 14 will be changed, so that the low-power capacitive proximity sensing circuit 160 would then actuate the RFID reader 14 to perform RFID signal reading. Furthermore, optionally, a photocoupler 2027 can be used to ensure a circuit loop created between the metal plate and the metal housing of the RFID lock 20 would not have any other substantial stray capacitance, because typically through MOS implementation, there are issues relating to gate to drain or gate to source stray capacitance, whereas the photocoupler 2027 possessing reduced amount of stray capacitance, and is completely cut off or segregated from other circuits, thus becoming a preferred option for implementation. Conventional capacitive proximity sensor typically measures capacitance changes in the range of about tens of pF.

For preventing the customized RFID transponder 12 in the RFID-to-Bluetooth selective adapter 10 from tampering or removal by criminal individuals to be later attaching a separate coil forming a rogue RFID tag, the RFID-to-Bluetooth selective adapter 10 can adopt system-on-chip (SoC) or System-In-Package (SiP) design and device structures to encapsulate the entire circuitry so as to avoid the possibility of being taken apart or disassemble due to reverse engineering efforts.

The RFID-to-Bluetooth selective adapter 10 and the smartphone 1 have encrypted communication under Bluetooth smart technology, having association models, including Just Works, Out of Band and Passkey Entry, multiple key generations for preserving confidentiality of data and device authentication, and device Identity. Encryption in Bluetooth Smart (low energy) technology uses AES-CCM cryptography, and the encryption is performed in the controller. As a result, the initiating packet will be different each time the smartphone 1 is used to perform authentication and activation of the RFID-to-Bluetooth selective adapter 10. As a result, the overall security and integrity of the integrated perimeter access control system is thus enhanced.

The RFID-to-Bluetooth selective adapter 10 of the embodiment of present application has reduced barrier to adoption due to the ease and convenience of being easily adapted to existing RFID locks 20 and RFID doorlock systems, and requiring only limited expenditure to cover purchase cost, installation cost and labor. In addition, there is no need to discard the existing RFID locks 20 or RFID doorlocks. Moreover, the physical size of the RFID-to-Bluetooth selective adapter 10 is relatively small in comparison with some of the available Bluetooth smart lock on the market, such as the Kwikset® Kevo deadbolt lock which has a very large interior hardware module that goes on the interior side of the door. Thus, the usage of the RFID-to-Bluetooth selective adapter 10 allows typical home owner or property owner/manager to provision electronic keys securely by internet to any designated or chosen individual(s) under various different access control duration or schemes (i.e. the electronic key can allow for access for just one entry, for multiple entry within one day or specified days, for one month, etc.) so that the hassle of exchanging physical RFID keys are thereby avoided.

A RFID-to-Bluetooth selective adapter having a more secured system design by adopting a defense in depth approach for the sake of security protection and maintaining integrity for the smart lock system is disclosed as follow according to a second embodiment of present invention. The second embodiment of the RFID-to-Bluetooth selective adapter includes a Bluetooth module MAC address 210, an activation key 220, and a registration key 230. Referring to FIG. 5 of the U.S. application Ser. No. 14/623,464, which later becomes U.S. Pat. No. 9,087,246, the MAC address 210, the activation key 220, and the registration key 230 are securely stored in the memory 1120 disposed in the Bluetooth module 11 of the RFID-to-Bluetooth selective adapter 10. The MAC address 210 and the activation key 220 for the RFID-to-Bluetooth selective adapter 10 are kept without being changed (permanent or constant) later on. Meanwhile, the registration key 230 is obtained by the user after registering of the RFID-to-Bluetooth selective adapter 10 using the APP. The MAC Address 210 is a serial number of 6 bytes in length, such as 12:34:56:67:9A:BC, the activation key 220 is a string of 16 bytes. Each device has a unique MAC address and activation key. The cloud based authentication server contains a copy of the MAC address serial number, and the activation key 220.

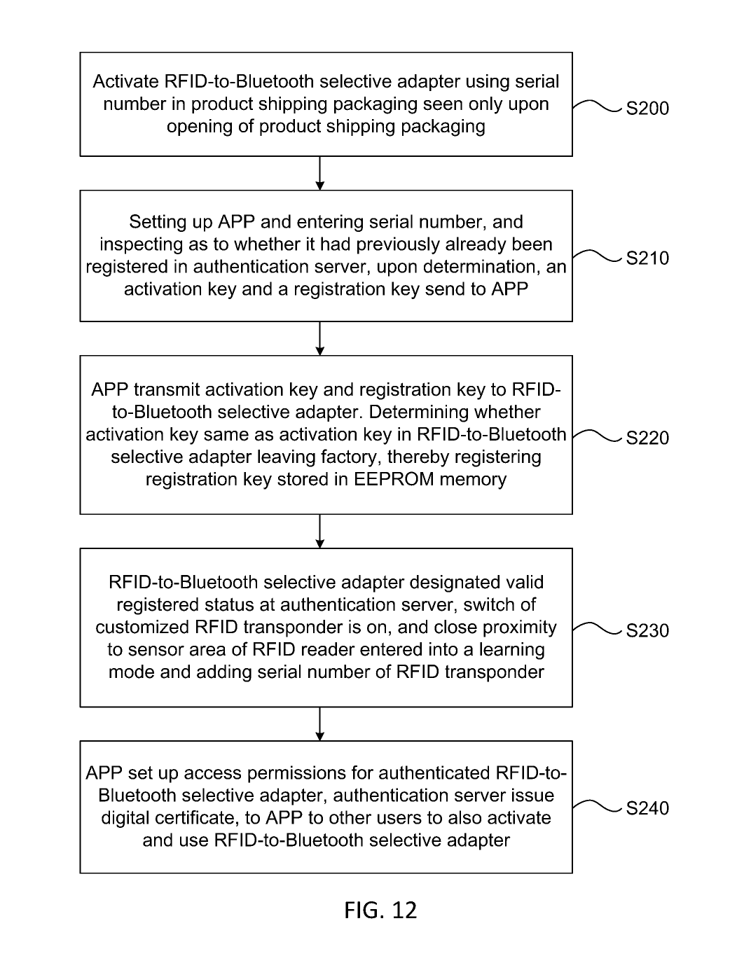

Referring to FIG. 12, a configuration method of the RFID-to-Bluetooth selective adapter for the second embodiment is described for an initial configuration of the RFID-to-Bluetooth selective adapter using an APP to include the following steps:

In Step S200, the RFID-to-Bluetooth selective adapter is turned on and activated, to be entering into a setup mode, in which a product shipping packaging of the RFID-to-Bluetooth selective adapter contains an serial number therein, The serial number of the RFID-to-Bluetooth selective adapter can only been seen upon opening of the shipping packaging to remove the RFID-to-Bluetooth selective adapter, so that when sealed such as prior to be purchased or during shipping, the packaged RFID-to-Bluetooth selective adapter would not reveal the serial number to any bystander.

In Step S210, a user can go to an APP store to download an APP that is configured to provide wireless access management and control of the RFID lock using the RFID-to-Bluetooth selective adapter via BLE communications. Upon opening the APP for the first time, the smartphone 1 receives communication signals from the RFID-to-Bluetooth selective adapter so as to enter into two-way communication with the RFID-to-Bluetooth selective adapter, in which the serial number is entered into a field in a RFID-to-Bluetooth selective adapter setup page in the APP. The serial number is then sent by the APP to the cloud based authentication server for authentication. Upon inspecting as to whether the serial number of the RFID-to-Bluetooth selective adapter had previously already been registered in the cloud based authentication server, the cloud based authentication server then send back an activation key and provisions a registration key (see FIG. 11) to the APP in the smartphone 1.

In Step S220, the APP then transmits the activation key and the registration key from the cloud based authentication server to the RFID-to-Bluetooth selective adapter. Upon inspecting and determining as to whether the activation key from the cloud based authentication server is the same as the activation key in RFID-to-Bluetooth selective adapter (which was originally provided by the manufacturer upon leaving the factory), thereby registering the registration key (refer to FIG. 6 of U.S. Pat. No. 9,087,246) to the RFID-to-Bluetooth selective adapter to be securely stored in the EEPROM memory disposed in the Bluetooth module.

In Step S230, the RFID-to-Bluetooth selective adapter is being designated as under a valid registered status at the cloud based authentication server, so that the switch of the customized RFID transponder is on. The RFID-to-Bluetooth selective adapter is to be directly attached or disposed at close proximity to the sensor area of the RFID reader of the RFID lock 20, and to launch the RFID reader to enter into a learning mode for learning and adding a unique serial number of the RFID transponder (such as the identification code of the RFID chip or the registration key in the EEPROM memory of the Bluetooth module), thus completing the training for the RFID reader.

In Step S240, the APP is used to set up access rights and permissions for the authenticated RFID-to-Bluetooth selective adapter, the cloud based authentication server can issue a digital certificate, such as a perpetual certificate or a temporary certificate, to the APP on the smartphone 1 to be transmitted to other users who have also downloaded and setup the APP on their smartphones 1 so as to be able to activate and use the RFID-to-Bluetooth selective adapter.

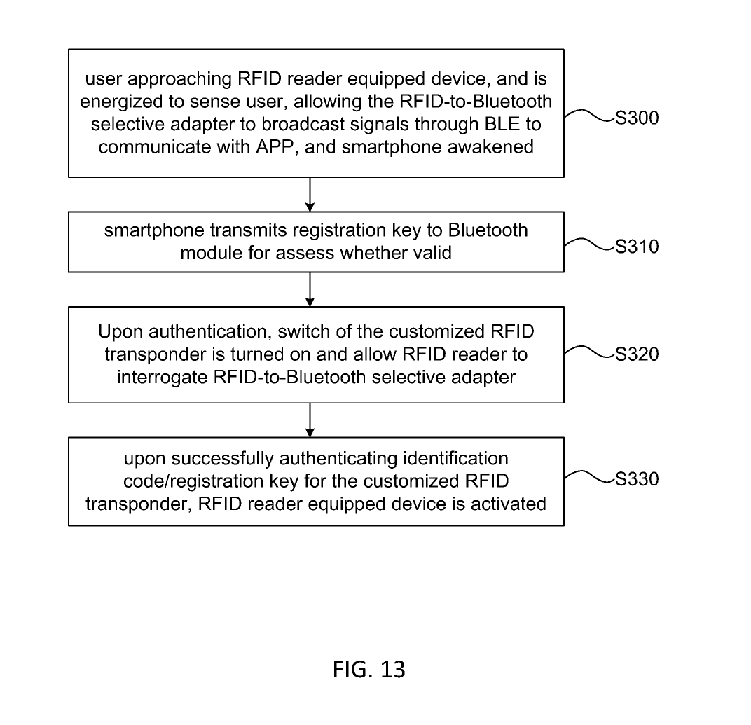

Referring to FIG. 13, an operating method of the RFID-to-Bluetooth selective adapter of the second embodiment is described to include the following steps:

In Step S300, when the user is approaching at close proximity to the RFID lock, the RFID reader of the RFID lock is energized through the use of a proximity sensor, to sense the user located at close proximity thereof, which in turn, will allow the RFID-to-Bluetooth selective adapter to broadcast signals through BLE, and the smartphone 1 would then be notified to be awakened and activated.

In Step S310, the smartphone 1 transmits the registration key to the RFID-to-Bluetooth selective adapter via BLE to the Bluetooth module inside therein, the RFID-to-Bluetooth selective adapter assesses as to whether the registration key transmitted from the smartphone 1 is valid or expired or invalid by comparing against the copy of stored registration key therein.

In Step S320, upon successful authentication by the Bluetooth module, the switch of the customized RFID transponder inside the RFID-to-Bluetooth selective adapter is turned on by turning on the on/off switch of the customized RFID transponder in the RFID-to-Bluetooth selective adapter, so as allow the RFID reader of the RFID lock to interrogate and read the customized RFID transponder inside the RFID-to-Bluetooth selective adapter.

In Step S330, upon successfully verifying or authenticating the identification code/registration key for the customized RFID transponder of the RFID-to-Bluetooth selective adapter, the RFID lock is activated.

A low cost and low power consumption one axis or three-axis motion sensor can be included in the customized RFID transponder of the second embodiment, to be used for detecting and sensing whether the 3D orientation thereof has been changed significantly due to outside tampering or complete removal thereof. Since the RFID-to-Bluetooth selective adapter is typically adhered in a vertical orientation with respect to the ground plane, and thus by tabulating and recording the real-time 3D orientation detected by the motion sensor over time, the motion sensor can easily detect abnormal or sudden orientation changes caused by forced removal or disassembly or theft of the RFID-to-Bluetooth selective adapter from the RFID reader equipped device, thus leaving the smart doorlock system. In response to this sudden changes in orientation thereof, the RFID-to-Bluetooth selective adapter can switch to operate in a self-destruct mode, in which both the registration key or the certification data are both wiped clean from an EEPROM memory thereof, so that no one can read the registration key or the certification data that were previously saved. At the same time, the resulting RFID-to-Bluetooth selective adapter with the wiped-clean EEPROM memory would be render disabled and non-functioning. Furthermore, when attempting to manually remove the customized RFID transponder from the RFID-to-Bluetooth selective adapter to make a rogue RFID tag (posing or pretending as an genuine RFID-to-Bluetooth selective adapter) to be read by the RFID reader of the RFID lock, the adoption of SoC (System-on-chip) or SiP (System-in-Package) packaging configuration for the entire RFID-to-Bluetooth selective adapter, which includes the Bluetooth module, along with the customized RFID transponder, and the on/off switch for the customized RFID transponder to be formed onto one single chip, in combination with using opaque encapsulating adhesive to protect the RFID-to-Bluetooth selective adapter of the second embodiment of present invention so as to achieve improved tampering resistance and prevent reverse engineering efforts by thieves attempting to steal the registration key data. The APP requires to have the registration key that is proper authenticated to be able to perform decryption correctly, thus, the initiation packet broadcasted by the RFID-to-Bluetooth selective adapter during interrogation of the smartphone 1 through BLE communication (for authentication) will be different each time. Thus, even when the communication data between the smartphone 1 and the RFID-to-Bluetooth selective adapter has been intercepted and spoofed by hacker or unauthorized third-party, the encrypted communication data would not likely to be properly decrypted without having the registration key. The APP residing on the smartphone 1 can have the registration key stored therein, thus allowing off-line (without internet access) full communication with the RFID-to-Bluetooth selective adapter.

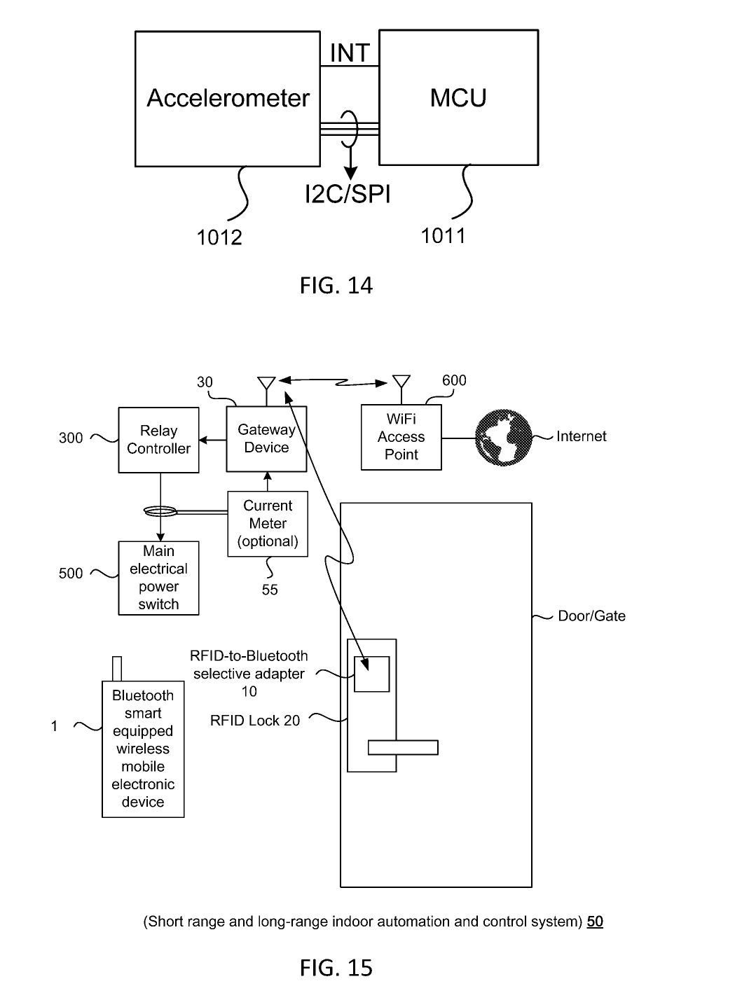

Referring to FIG. 14, an accelerometer circuit is provided as an optional item for the RFID-to-Bluetooth selective adapter 10 to use as theft deterrent feature, so that when anyone attempts to remove the RFID-to-Bluetooth selective adapter 10 from the sensor area of the RFID reader of the RFID lock 20, the accelerometer (also known as G-sensor) circuit detects such motion or movement and would send a cut off signal (INT) to the BLE SoC or BLE MCU to turn off the on/off switch, which is equivalent to the turning off of the RFID IC for door opening actions. An actual implementation example of the accelerometer 1012 is for example STMicroelectronic model no. LIS2DH12, three-axis linear accelerometer.

In one embodiment, the BLE MCU 1011 upon activation, will send out a configuration signal INT under Inter Integrated Circuit Communications (I2C) or Serial-Peripheral interface (SPI) (protocols) to the accelerometer 1012 to notify the detected frequency and the interrupt threshold, and when the accelerometer (G-sensor) 1012 detects gravitational direction changes to be exceeding the interrupt threshold, the on/off switch is switched to the off position. In one illustrative example, the accelerometer (G-sensor) 1012 can operate under 2 microamps (uA) quiescent current, with a detecting frequency at 1 Hz.

In order to ensure that no unauthorized individual steal and gaining full access to the smartphone 1, the APP on the smartphone 1, in an alternative embodiment, can be configured with an APP access password to be stored on the smartphone 1, thus each time when the APP is activated for usage, the user needs to input the correct APP access password to gain full access to the range of services offered by the RFID-to-Bluetooth selective adapter.

In the above embodiments, upon realizing the loss or disappearance of the smartphone 1, a portal website for the APP or the APP residing on another smartphone 1 can be used to perform remote log off for the account on the disappeared smartphone 1 so as to eliminate the possibility of unauthorized person gaining usage of the APP in the disappeared smartphone 1. Upon activating the APP in the disappeared smartphone 1, the APP will automatically log off via internet access. In addition, the APP residing on the smartphones 1 are wirelessly connected to the cloud based authentication server via SSL security protocol over internet, for protecting against hackers sniffing and spoofing. Meanwhile, because the RFID-to-Bluetooth selective adapter requires product registration upon product activation during first time usage, and any subsequent unauthorized user would not have access to the original device serial number found in the product shipping packaging of the RFID-to-Bluetooth selective adapter, thus the risk of hijacking of the RFID-to-Bluetooth selective adapter for improper usage is dramatically reduced.

The RFID-to-Bluetooth selective adapter of the embodiments of present invention permits the RFID locks to also support Bluetooth input without affect existing RFID operations. A user can use a smartphone 1 or any electronic device with BLE or Bluetooth smart capability to activate (turn on and turn off or open and close) or open/close various RFID locks 20 or RFID reader equipped devices, such as RFID smart doorlocks, thereby allowing family members improved ease of entry access to individual homes, and allowing single-entry or time-based entry access by friends, tutors, electricians, plumbers, realtors into homes and various controlled access spaces.

The RFID-to-Bluetooth selective adapter 10 through the usage of an APP configured in the smartphone 1/BLE equipped device and a cloud based authentication server can thereby provide various different access rights and settings for various users using the RFID smart doorlocks.

In the embodiments, the RFID-to-Bluetooth selective adapter 10 can be further configured to automatically report back the tabulated historical usage activities data of the RFID lock to be stored in an activity log and managed by and viewed on the mobile phone APP.

In another embodiment of present invention, a simplified RFID-to-Bluetooth selective adapter can have just a traditional RFID transponder, a conventional antenna, an on/off switch at the antenna terminal, and a conventional Bluetooth module. The conventional Bluetooth module is specifically configured to turn on and off the on/off switch at the antenna to control whether or not the traditional RFID transponder would be activated and by a RFID reader's communication signals. The components of the simplified RFID-to-Bluetooth selective adapter can be realized on a PCB board.

In yet another embodiment of present invention, an upgraded version of the RFID-to-Bluetooth selective adapter 10 can adopt SoC (System-on-chip) design to combine the Bluetooth module and the customized RFID transponder together onto a single chip, as well as placing the Bluetooth module and the RFID antenna printed on a flexible printed circuit board (FPC), with a combined weight less than 5 grams, and as thin as paper (<1 mm in thickness). The upgraded version of the RFID-to-Bluetooth selective adapter can be laminated or adhered to the RFID reader (like the way a 3M™ wound dressing tape works above a wound area) of the RFID lock 20, thereby becoming less conspicuous and aesthetically more pleasing, as well as being very easy to install. In addition, the APP can also have various security upgrades such as adopting of biometric authentication scanner, advanced password entry, facial recognition, fingerprint authentication, etc.

As shown in FIG. 15, a short range and long-range indoor automation and control system 50 is provided according to a first embodiment of present invention. The short range and long-range indoor automation and control system 50 includes a Bluetooth smart equipped wireless mobile electronic device 1, such as a smartphone 1 or a wearable electronic device 1, a RFID-to-Bluetooth selective adapter 10, a RFID Lock 20, a WiFi access point 600 that is connected to the internet, a current meter 55 (optional), a gateway device 30, a relay controller 300, and a main electrical power switch 500. The RFID-to-Bluetooth selective adapter 10 is installed or attached onto the RFID lock 20. The RFID lock 20 has a RFID reader therein, and is mounted onto the door. The RFID-to-Bluetooth selective adapter 10 of the illustrated embodiment can be the RFID-to-Bluetooth selective adapter (10), and the RFID lock 20 can be the RFID reader equipped device (17) described in U.S. application Ser. No. 14/623,464, which later becomes U.S. Pat. No. 9,087,246. The short range automation and control mode operates without internet connection, the long-range mode operating under internet connection. The short-range can also be called near-range (without using internet connection), and the long-range can also be called distant-range or far-range (requiring to have internet connection). The conventional energy saving key card holder (not shown) that are typically found in hotel rooms can be modified to allow control by the gateway device 30, and the energy saving key card holder can be replaced by the relay controller 300. The relay controller 300 can be a programmable relay controller. Unlike the conventional activating signal which is obtained by means of an insertion of a properly authenticated key card into the energy saving key card holder, the gateway device 30 provides the same activating signal through different authentication methods in the first embodiment of present invention. The gateway device 30 and the relay controller 300 can be coupled together in a wired or wireless manner. For rooms that are difficult to have electrical or cable wiring installed, wireless connection between the gateway device 30 and the relay controller 300 can be an effective solution without excess modification required. According to one embodiment of the present invention, a relay controller 300 and a current meter 55 can be integrated and installed within one physical module. In alternative embodiment, the gateway device 30, the current meter 55 and the relay controller 300 can all be installed in an energy saving key card holder (but without actually utilizing the conventional functionality of the energy saving key card holder itself). For instance, the conventional energy saving key card holder requires to have a properly-authenticated RFID card to be inserted therein so as to allow provisioning of power to the respective connected electrical devices. The use of the RFID-to-bluetooth selective adapter 10 together with the smartphone 1 in the illustrated embodiment, can thereby eliminate the need of inserting of the properly-authenticated RFID key card into the energy saving key card holder for allowing continued power on of electrical or electronic devices while the occupant is inside the room. In the illustrated embodiment, there is no need to place any RFID key card or smartphone on or near the gateway device 30 or the relay controller 300. Electrical current readings from the current meter 55 can be sent to the gateway device 30, which is then stored in the cloud in a server on the internet. In the illustrated embodiment, the internet connection capabilities of the gateway device 30 includes the following: one or more of WiFi, 3G/4G, Long Range (LoRa), Ultra Narrow Band (UNB) wireless communication protocols can be adopted for performing and handling the internet connection; if WiFi is already present within a confined region/space or a room (not shown), the gateway device 30 can directly be connected to the WiFi access points (AP) 600 to achieve internet connection capability; if WiFi is not already present within the confined region, the gateway device 30 can be connected to nearby base station (not shown) via a 3G/4G baseband transmission module (not shown) to achieve internet connection capability; because the data transmission rate of the gateway device 30 itself is relatively low, it is more cost effective to utilize LoRa or UNB wireless communication technologies. The LoRa and UNB is a physical transmission layer (100 bps-5 k bps) with a low baud rate, and can be transmitted under low power consumption. The transmission distance under line-of-sight condition can reach several kilometers. Just one LoRa or UNB access point needs to be installed or disposed within the confined space for providing space management applications or utilities; when the gateway device 30 is not able to connect to internet, the short-range functionalities including door opening, power provisioning, power shut off can still maintain normal operation, just that the long-range functionalities would be not be activated or operating. Using the short range and long-range indoor automation and control system 50 of the first embodiment, short range/near-range (without internet connection) or long-range/distant-range (requiring internet connection) power on/off management and control (including turning power on and turning power off) of electrical or electronic device disposed in the confined region or room can be achieved and provided by power on (turn on) or power off (turn off) of a main power switch, even in real-time. In addition, users or occupants can use smartphones 1 or wearable devices' Bluetooth wireless communication capability to be connected to the gateway device 30 to issue power on or power off signals to connected electrical devices. As a result, users or administrator or property manager/owner or occupants can remotely control the power on and power off (power on/off management) using the long-range control method via internet connection, which is performed wirelessly to transmit the control packet through the WiFi access point 600 to the gateway device 30, which then issue the control command.

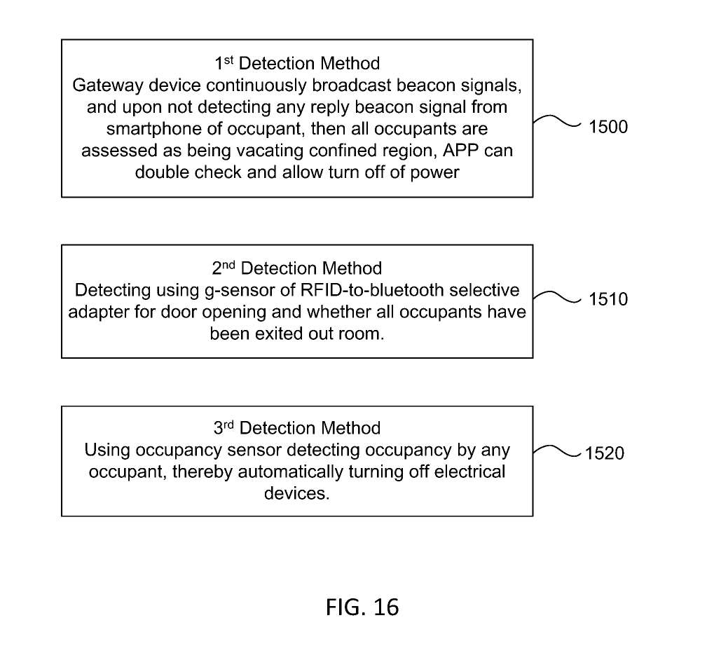

In the illustrated embodiment for FIG. 16, three detection methods can be provided for determining whether any occupant is located or disposed inside a confined space/room as follow: A first detection method 1500 is described as follow: the gateway device 30 continuously broadcast beacon signals, and upon not detecting any reply beacon signal from the smartphone 1 of the occupant, then all occupants are assessed as being possibly departing or left the confined region/room. At this time, the APP can launch a query to one occupant to ask if anyone is still within the confined region/room, and also whether or not turn off all electrical connections to save power, and if so, transmitting the power off signal to the gateway device 30 via internet connection. A second detection method 1510 is described as follow: the RFID-to-bluetooth selective adapter is configured with a g-sensor or a vibration sensor therein for detecting door opening, such as for example, if the door opening motion is detected while the switch on the RFID-to-bluetooth selective adapter is not being depressed/pressed, then all occupant is reasoned to have been exited out or left the room. A third detection method 1520 is described as follow: an occupancy sensor as taught in http://en.wikipedia.org/wiki/Occupancy_sensor is installed so as to be detecting occupancy of a space by any occupant thereof, and upon not detecting any reflected signal changes, the electrical devices are thereby automatically turned off. One or more of the above detection methods for determining whether any occupant is located or disposed inside a confined space can be used in actual implementation.

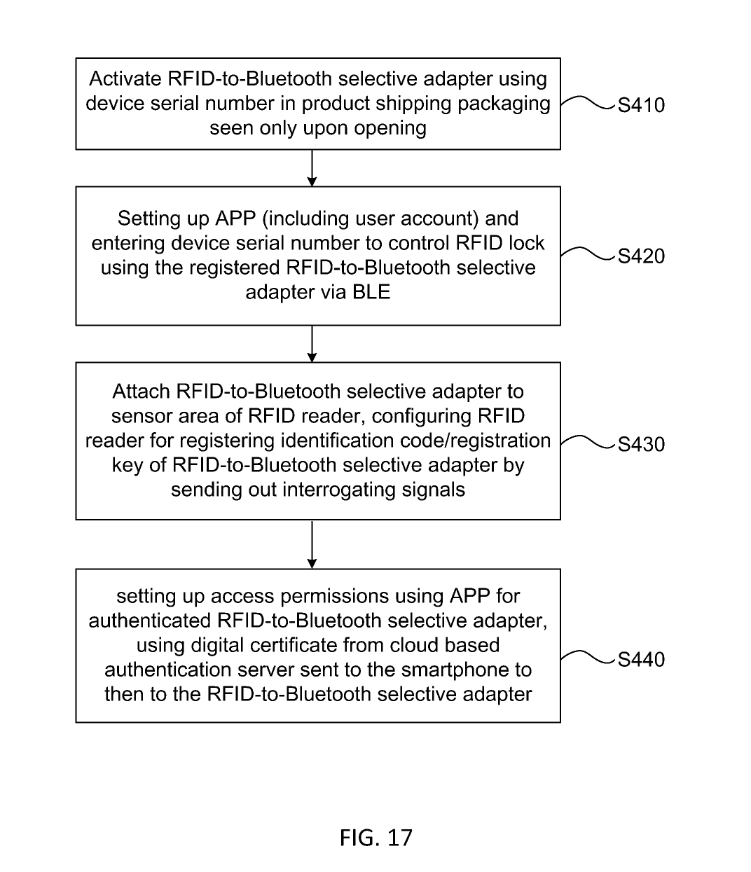

Referring to FIG. 17, a first time initial configuration method of the RFID-to-Bluetooth selective adapter 10 of the first embodiment is described using an APP to include the following steps: In Step S410, the RFID-to-Bluetooth selective adapter 10 is activated/turned on, to be entering into a setup mode, in which a product shipping packaging of the RFID-to-Bluetooth selective adapter 10 contains a device serial number therein, which can a string of alphanumeric number or a QR code. The device serial number of the RFID-to-Bluetooth selective adapter 10 can only be seen or read upon opening of the shipping packaging to remove the RFID-to-Bluetooth selective adapter 10, so that when sealed, the packaged RFID-to-Bluetooth selective adapter 10 would not reveal the device serial number to any bystander. In Step S420, a user can go to an APP store to download an APP that is configured to provide wireless access management and control of the RFID lock 20 using the RFID-to-Bluetooth selective adapter 10 via BLE communications. Upon opening the APP for the first time, an user account is required to be set for the user, and upon successfully setting up the user account on the smartphone 1, the device serial number is entered to register the RFID-to-Bluetooth selective adapter 10 as an authenticated trusted device in a cloud based authentication server on the internet. In Step S430, the RFID-to-Bluetooth selective adapter 10 is to be directly attached or disposed at close proximity to the sensor area of the RFID reader 14 of the RFID lock 20, and to launch or initiate the RFID reader 14 to enter into a configuration mode for adding a new identification code/registration key of the RFID-to-Bluetooth selective adapter 10. The RFID reader 14 is to read a signal for an identification code/registration key for a customized RFID transponder (not shown) of the RFID-to-Bluetooth selective adapter 10 by sending out an interrogating signal to the RFID transponder (not shown) of the RFID-to-Bluetooth selective adapter 10 so as to perform registering of the identification code/registration key for the RFID-to-Bluetooth selective adapter 10. The identification code/registration key is a hexadecimal ID string of 16 bytes In Step S440, the APP is used to set up access rights and permissions for the authenticated RFID-to-Bluetooth selective adapter 10, the cloud based authentication server can issue a digital certificate which is an encrypted digital file to the smartphone 1 to be transmitted to the RFID-to-Bluetooth selective adapter 10, or the digital certificate can be issued instead through a third party trusted certificate authority. This digital certificate can be a perpetual certificate or a timed duration certificate.

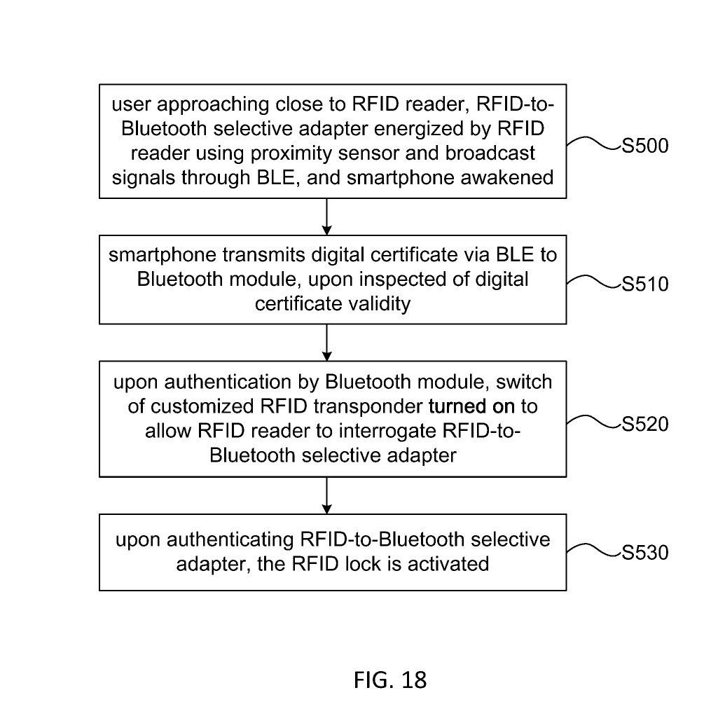

Referring to FIG. 18, an operating method of the RFID-to-Bluetooth selective adapter 10 of the first embodiment is described to include the following steps: In Step S500, when the user is approaching close by or at close proximity to the RFID lock 20, the RFID-to-Bluetooth selective adapter 10 is energized by the interrogating signals from the RFID reader 14 of the RFID lock 20 (the RFID reader 14 has an inductor coil which broadcast the interrogating signals) when the RFID lock 20, through the use of a proximity sensor, or the like, is able to sense the user located at close proximity thereof, which in turn, will allow the RFID-to-Bluetooth selective adapter 10 to broadcast signals through Bluetooth or BLE, and the smartphone 1 (or any wearable electronic device) in Bluetooth/BLE broadcast coverage range would then intercept the broadcast signal to be automatically awakened and activated. In Step S510, the smartphone 1 (or the wearable electronic device) transmits the digital certificate to the RFID-to-Bluetooth selective adapter 10 via BLE to a Bluetooth module (not shown) inside therein, the RFID-to-Bluetooth selective adapter 10 is to inspect as to whether the digital certificate is valid or expired or invalid. Without having any authenticated smartphone 1 or wearable mobile device being properly configured by the smart doorlock remote control APP, or in other words, if the user is not using any smartphone 1 or that the smartphone 1 has yet to be installed with the APP, the user can still use a conventional RFID tag or RFID smart card to be placed on or above the sensor area of the RFID lock 20 for performing proper access control usage (i.e. open or close the door, turn on and turn off the door lock). In Step S520, upon successful authentication by the Bluetooth module, a switch (not shown) of the customized RFID transponder (not shown) inside the RFID-to-Bluetooth selective adapter 10 is turned on by turning on the on/off switch of the customized RFID transponder in the RFID-to-Bluetooth selective adapter 10, so as allow the RFID reader 14 of the RFID lock 20 to interrogate and read the customized RFID transponder (not shown) inside the RFID-to-Bluetooth selective adapter 10. In Step S530, upon successfully verifying or authenticating the ID string for the customized RFID transponder of the RFID-to-Bluetooth selective adapter 10, the RFID lock 20 is activated. For the sake of power conservation, the RFID reader 14 of the RFID lock 20 would not be operating under continuously sensing mode of nearby EMF signals (typically operating under current of dozens of milliamps, mA), only when the RFID reader 14 is placed in close proximity to the user, would then trigger activation of the RFID reader 14 to perform EMF signal sensing by the RFID reader 14, in this manner, various sensing methods such as by infrared LED, ultrasonic sensing, microwave sensing, which are low-power sensing methods . . . (requiring current in the tens of microamps, uA) can be used. The energy from the EMF signals of the RFID lock 20 can be used to power on the RFID-to-Bluetooth selective adapter 10, so that Bluetooth or BLE communication from the RFID-to-Bluetooth selective adapter 10 can be established with the adjacent smartphone 1 to perform two way communications using the APP providing wireless access management and control of the RFID lock 20 through the RFID-to-Bluetooth selective adapter 10 downloaded in the smartphone 1. Under typical operation, the power consumption of the RFID-to-Bluetooth selective adapter 10 is about 5 microamps, or 5 uA.

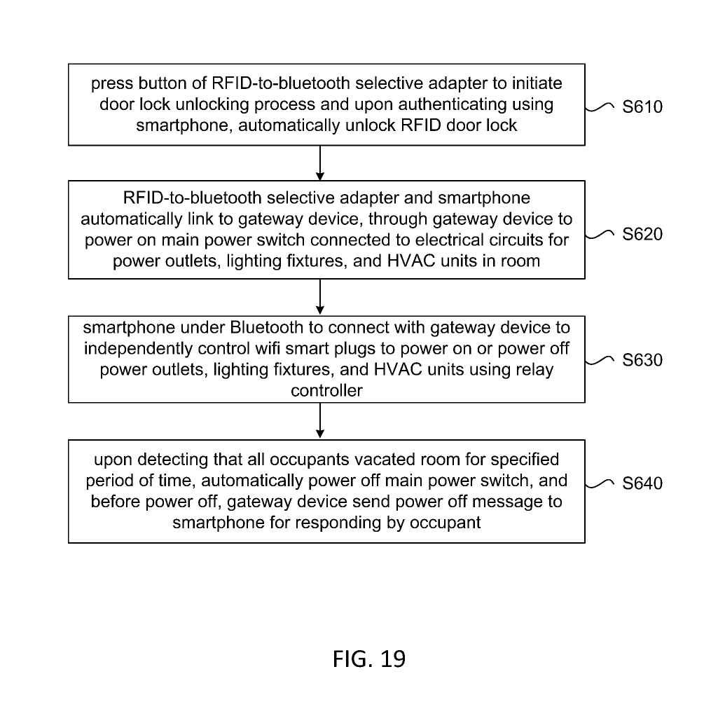

Referring to FIG. 19, a flow chart diagram showing a short-range operating method (which requires the download of an APP, and the gateway device 30 not connected to the internet) for indoor automation and control system of an embodiment includes the following steps: In Step S610, a button of the RFID-to-bluetooth selective adapter 10 (the RFID-to-bluetooth selective adapter is disposed or adhered to a sensor area of the RFID lock) is pressed down to initiate the RFID lock unlocking process; upon successfully authenticating that the digital certificate is valid using the smartphone 1 or wearable device, the RFID lock is then automatically unlocked. In Step S620, the RFID-to-bluetooth selective adapter 10, the smartphone 1 or the wearable device automatically link or connect with the gateway device 30 to activate a power supply to electrical and electronic devices that are connect to one or more electrical circuits configured for the confined region/room by turning on/power on a main power switch, in which the main power switch is connected to a plurality of electrical circuits configured for a plurality of power outlets, a plurality of lighting fixtures, and a plurality of HVAC units. In Step S630, the smartphone 1 can operate under Bluetooth mode to connect with the gateway device 30 to thereby independently control the power supply of the power outlets/electrical outlets, the lighting level or intensity, the air conditioner or heater temperature (HVAC) settings, and the television remote control settings by independently controlling a plurality of wifi smart plugs to power on or power off the power outlets, the lighting fixtures, and the HVAC units using the relay controller 300. In Step S640. upon detecting that all occupants to have been vacated or left the room or confined region for a specified period of time (2 minutes to 5 minutes), power outlets or electrical outlets in the room are automatically shut off by power off the main power switch; meanwhile before shutting off or power off, the gateway device 30 will send a power off message to the smartphone 1, and if the smartphone 1 is still situated or located within the room, the occupant can respond by acknowledging that power is still needed to be turned on, thus avoiding premature or accidental power shut off.

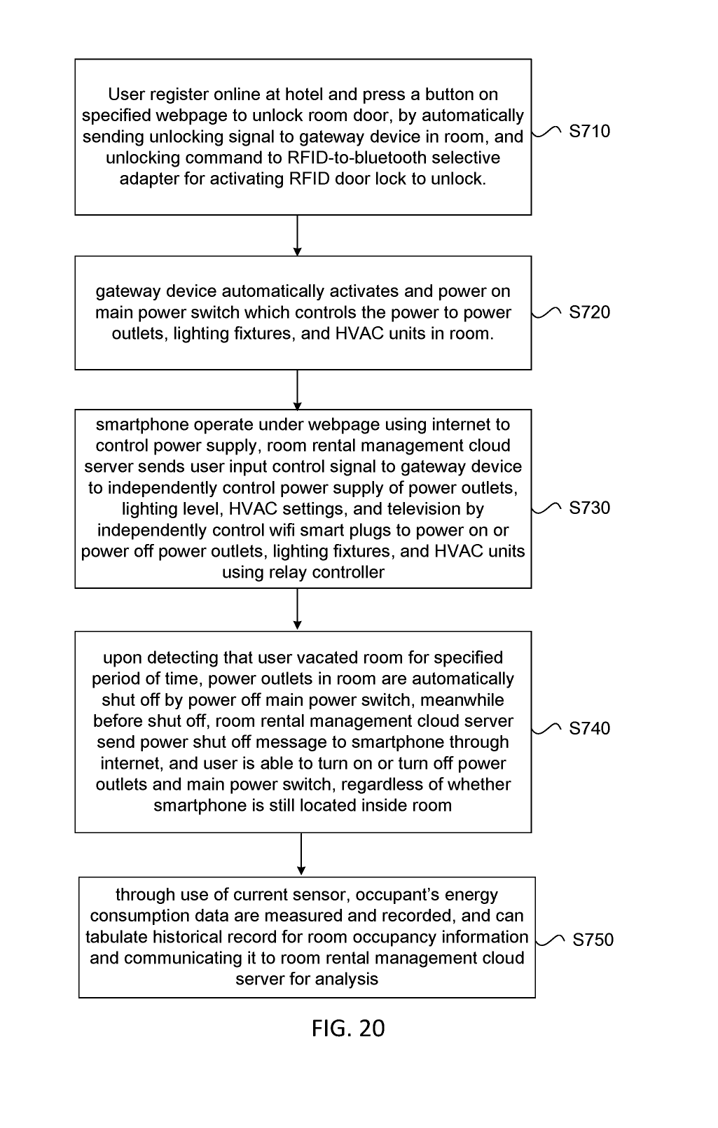

Referring to FIG. 20, a flow chart diagram showing a long-range operating method (can be browser controller, thus does not requires the download of an APP, and the gateway device 30 is required to be connected to the internet) for a hospitality accommodation establishment automation and control system includes the following steps: In Step S710, a user can register online at the hotel (or any other hospitality accommodation establishment), and press a button on a specified webpage (the specified webpage is a secure webpage particular designed for the hotel guest to sign-on/sign-in during check-in or check-out) to unlock the room door of a rented room by the user. A room rental management cloud server 65 then automatically sends a door lock unlocking signal to the gateway device 30 in the rented room, the gateway device 30 then automatically sends an unlocking command to the RFID-to-bluetooth selective adapter 10 for activating the RFID lock 20 to unlock. In Step S720, the gateway device 30 automatically activates and power on a main power switch which controls the power supply to the power outlets/electrical outlets, lighting fixtures, and HVAC units in the room. In Step S730, the smartphone 1 can operate under the specified webpage (the specified webpage is a secure webpage also particular designed for the hotel guest to perform various remote control commands during his or her stay in the room) using internet to control the power supply of the power outlets, the room rental management cloud server 65 then sends one or more user input control signal to the gateway device 30 in the rented room in real time to connect with the gateway device 30 to thereby independently control the power supply of the power outlets, the lighting level or intensity, the air conditioner or heater temperature (HVAC) settings, and the television remote control settings by independently controlling a plurality of wifi smart plugs to power on or power off the power outlets, the lighting fixtures, and the HVAC units using the relay controller 300. In Step S740, upon detecting that the user to have been vacated or left the room for a specified period of time (2 minutes to 5 minutes), the power outlets in the room are automatically shut off by power off the main power switch, meanwhile before shut off, the room rental management cloud server 65 will send the power shut-off message to the smartphone 1 through the internet connection, and the user is able to turn on or turn off the power outlets and the main power switch, regardless of whether the smartphone 1 is still located inside the room or not. In Step S750, through the use of the current sensor, the occupant's electricity and energy consumption data can be measured and recorded, and can tabulate also historical record for room occupancy information, i.e. percent and duration of occupant staying inside the room versus outside the room, and communicating the historical record for room occupancy information to the room rental management cloud server 65 for analysis and other usages.

One advantage of the embodiments of present invention include the ability to perform the short-range operating method of FIG. 19 and the long-range operating method of FIG. 20 in one of the following operating scenarios: (a) switching between short-range or long-range automatically based on internet availability or user preference; (b) switching between short-range or long-range manually by an administrator override command by a property owner or manager, when for example, an emergency situation is suspected of occurring at the confined location/space, and the property owner needs to shut-off the power from a distant remote location; (c) switching between short-range or long-range manually by an occupant, due to personal preference or signal quality issues.

Another advantage of the embodiments of present invention include the seamless integration of the smart door access control system together with indoor automation and control system into one convenient system for perimeter access control.

Another advantage of the embodiments of present invention include the automatic power on and power off of various connected electrical and electronic devices in the confined space upon entering and exiting the room through the door with the RFID lock 20, respectively, using the RFID-to-Bluetooth selective adapter 10 and the smartphone 1/wearable device operating under Bluetooth upon secure authentication.

The RFID-to-Bluetooth selective adapter 10 of the embodiments of present invention has reduced barrier to adoption due to the ease and convenience of being easily adapted to existing RFID locks 20 or doorlock systems, and requiring only limited expenditure to cover purchase cost, installation cost and labor. In addition, there is no need to discard the existing RFID locks 20 or doorlock system. Moreover, the physical size of the RFID-to-Bluetooth selective adapter is relatively small in comparison with some of the available Bluetooth smart lock on the market. Thus, the usage of the RFID-to-Bluetooth selective adapter allows typical home owner or property owner/manager to provision electronic keys securely by internet to any designated or chosen individual(s) under various different access control duration or schemes (i.e. the electronic key can allow for access for just one entry, for multiple entry within one day or specified days, for one month, etc.) so that the hassle of exchanging physical RFID keys are thereby avoided.

The RFID-to-Bluetooth selective adapter 10 through the usage of an APP configured in the smartphone/BLE equipped device 1 and a cloud based authentication server (not shown) can thereby provide various different access rights and settings for various users using the RFID smart door lock 30.

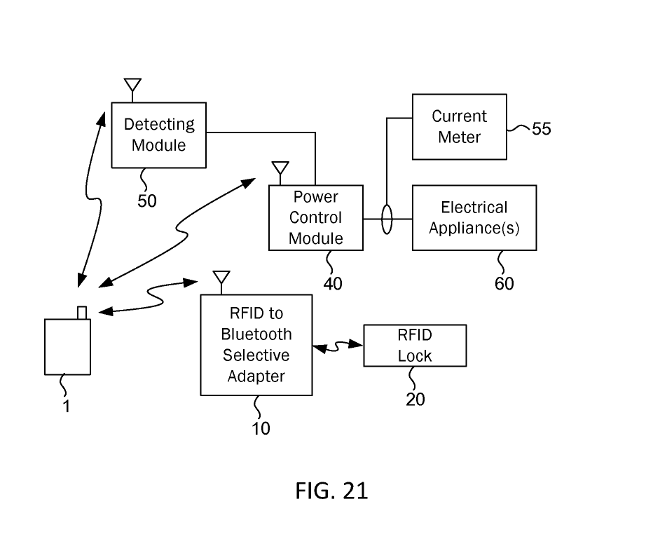

Referring to FIG. 21, a block diagram of a short range space management automation and control system in accordance to an embodiment of present invention is shown. In the illustrated embodiment, the short range space management automation and control system includes a Bluetooth smart equipped wireless mobile electronic device, such as a smartphone 1 or a wearable electronic device 1, one or more electrical appliances 60, a RFID-to-Bluetooth selective adapter 10, a RFID lock 20, a current meter 55, a detecting module 50 and a power control module 40. The RFID-to-Bluetooth selective adapter 10 is installed or at close proximity to the RFID lock 20. The RFID-to-Bluetooth selective adapter 10 and the RFID lock 20 being in close proximity to establish two-way communications. The RFID lock 20 has a RFID reader 14 therein, and is mounted onto a fixed or secure location such as the door. The RFID-to-Bluetooth selective adapter 10 of the illustrated embodiment can be the RFID-to-Bluetooth selective adapter (10), and the RFID lock 20 can be the RFID reader equipped device (17) described in U.S. application Ser. No. 14/623,464, which later becomes U.S. Pat. No. 9,087,246. In addition, the smartphone 1 is within two-way wireless communication range with the RFID-to-bluetooth selective adapter 10. The short range space management automation and control system operates without internet connection in this illustrated embodiment. The power control module 40 is coupled to the one or more electrical appliances 60, respectively, so as to allow provisioning of power thereof. The detecting module 50 is coupled to the power control module 40. The current meter 55 is configured to detect current readings of the power lines supplied to the one or more electrical appliances 60. The use of the RFID-to-bluetooth selective adapter 10 together with the smartphone 1 in the illustrated embodiment, can thereby eliminate the need of inserting of any properly-authenticated RFID key card into the energy saving key card holder for allowing continued power on of electrical appliances 60 while an occupant is inside the room.

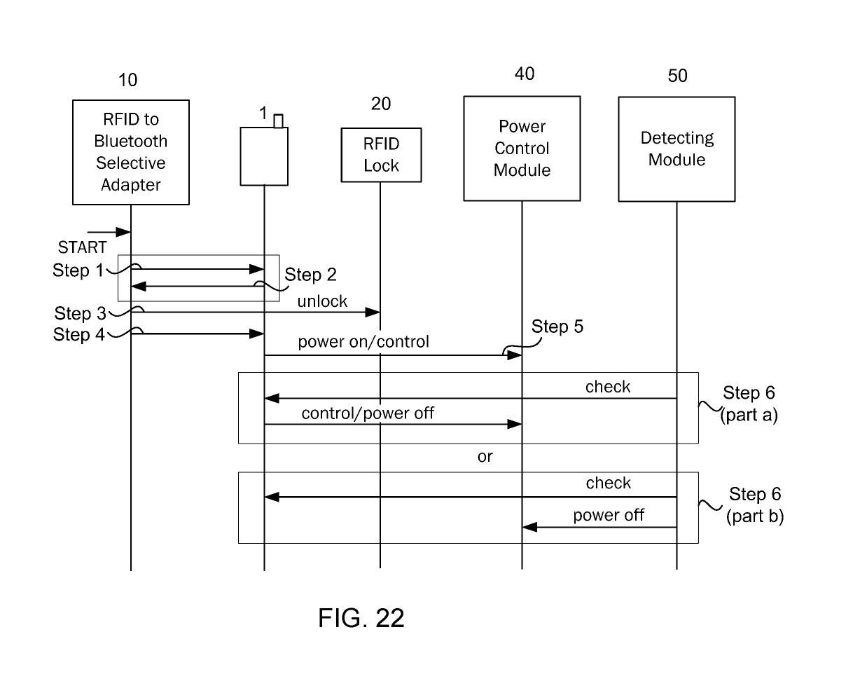

Referring to FIGS. 21 and 22, a simplified operation process flow schematic of a short range space management automation and control method of an embodiment is described and shown, which includes the following steps: In the first step, the RFID-to-bluetooth selective adapter 10 broadcast signals to the smartphone 1, through BLE protocol, and the smartphone 1 intercept the broadcast signal to be automatically activated. In the second step, the smartphone 1 (or the wearable electronic device) transmits a digital certificate to the RFID-to-Bluetooth selective adapter 10 via BLE protocol. In the third step, the RFID-to-Bluetooth selective adapter 10 is to inspect as to whether the digital certificate is valid or expired or invalid and upon successful authentication, the RFID lock 20 is unlocked. In the fourth step, RFID-to-Bluetooth selective adapter 10 transmit the digital certificate is valid or expired or invalid to the smartphone 1. In the fifth step, the RFID-to-Bluetooth selective adapter 10 instructs the smartphone 1 to control and power on the power control module 40 by passing along the administrator management privileges. In the sixth step (part a), the detecting module 50 can broadcast interrogation signals (to check) in the form of electromagnetic waves under low-power (requiring current in the tens of microamps, uA) to detect for presence of the smartphone 1, and upon recognizing the smartphone 1, to then request the smartphone 1 to control and power off the power control module 40; or alternatively, (part b) the detecting module 50 can broadcast interrogation signals (to check) in the form of electromagnetic waves under low-power and upon recognizing the smartphone 1, to directly power off the power control module 40. In a managed space (for example, inside a room) that is without any operating gateway device, the smartphone 1 itself of the occupant becomes the “pseudo-gateway” to control and power on/off of the power control module 40. When the detecting module 50 (through broadcasting interrogation signals) recognizes that the occupant has vacated the room, the detecting module 50 would then instruct the power control module 40 to be powered off. Meanwhile, if the occupant stays inside the managed space, the detecting module 50 would recognizes such condition and would allow the power control module 40 to remain powered on, without instructing the power control module 40 to power off. Meanwhile, if the detecting module 50 fails to receive a reply from the smartphone 1 within a specified amount of time, the occupant is then deemed to have vacated the room, such that the power control module 40 is instructed to be powered off. In the aforementioned short range space management automation and control method and the short range space management automation and control system of the embodiment, the electrical appliances 60 include such as lamps, lights, air conditioning unit, heater, radio, stereo, television, wall outlet, power outlet, lighting intensity, HVAC settings, and television remote control settings.

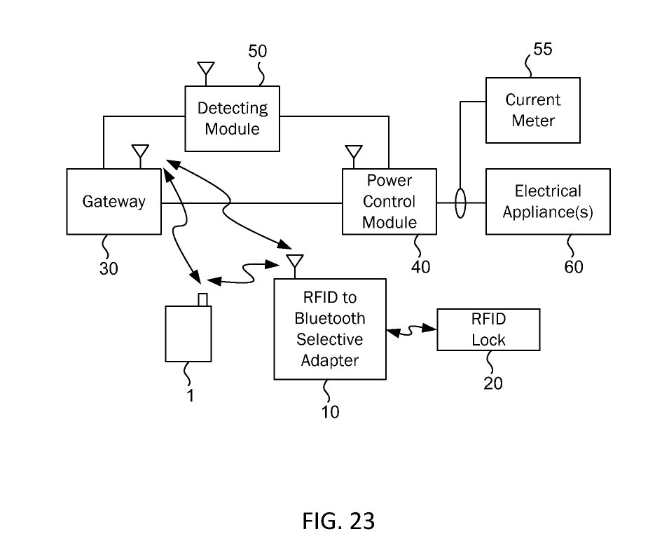

Referring to FIG. 23, a block diagram of a short range space management automation and control system in accordance to an another embodiment of present invention is shown. In the illustrated embodiment, the short range space management automation and control system includes a gateway device 30, a wireless mobile electronic device 1, such as a smartphone 1 or a wearable electronic device 1, one or more electrical appliances 60, a RFID-to-Bluetooth selective adapter 10, a RFID lock 20, a current meter 55, a detecting module 50 and a power control module 40. The gateway device 30 is coupled to the power control module 40 and the detecting module 50, respectively. The gateway device 30 is capable of maintaining two-way communication with the internet, the wireless mobile electronic device 1 and the RFID-to-Bluetooth selective adapter 10, respectively. The RFID-to-Bluetooth selective adapter 10 is installed at close proximity to the RFID lock 20. The RFID-to-bluetooth selective adapter 10 and the RFID lock 20 being in close proximity to establish two-way communications. The RFID lock 20 has a RFID reader therein. The RFID-to-Bluetooth selective adapter 10 of the illustrated embodiment can be the RFID-to-Bluetooth selective adapter (10), the RFID lock 20 can be the RFID reader equipped device (17) as described in U.S. application serial no. U.S. Ser. No. 14/623,464. The short range space management automation and control system of the illustrated another embodiment operates with internet connection. The power control module 40 is coupled to the one or more electrical appliances 60, respectively, so as to allow provisioning of power thereof. The current meter 55 is configured to detect current readings of the power lines supplied to the one or more electrical appliances 60.

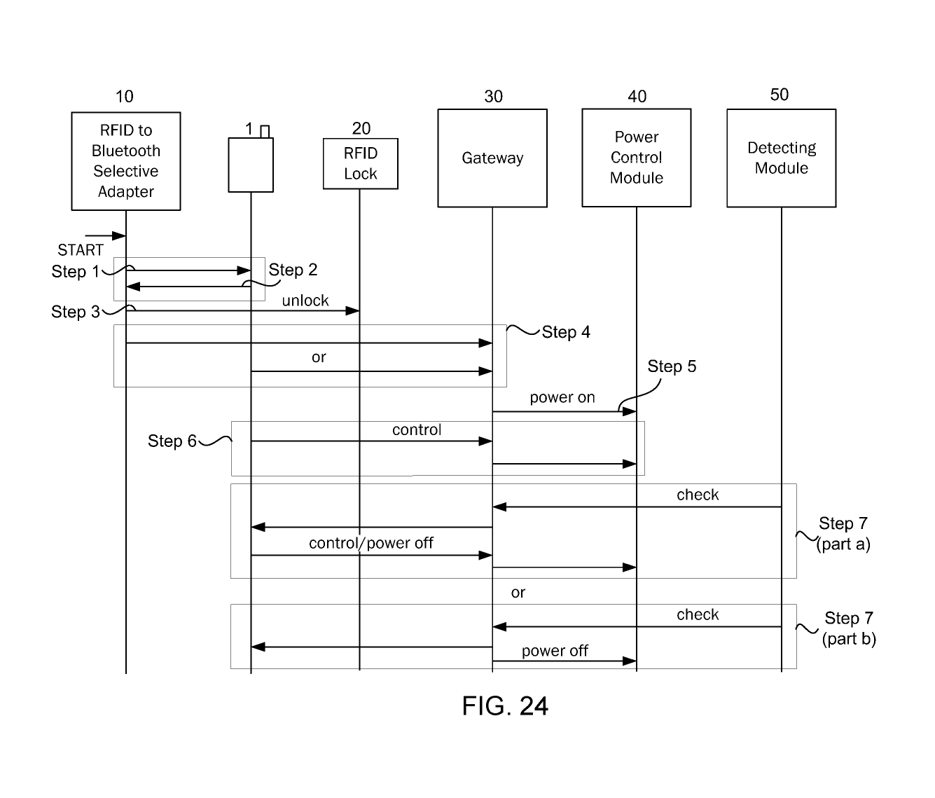

Referring to FIGS. 23 and 24, a simplified operation process flow schematic of the short range space management automation and control method of the another embodiment is described and shown, which includes the following steps: In the first step, the RFID-to-bluetooth selective adapter 10 broadcast signals to the wireless mobile electronic device 1, through Bluetooth, and the wireless mobile electronic device 1 intercept the broadcast signal to be automatically activated. In the second step, the wireless mobile electronic device 1 transmits a digital certificate to the RFID-to-Bluetooth selective adapter 10 via Bluetooth. In the third step, the RFID-to-Bluetooth selective adapter 10 is to inspect as to whether the digital certificate is valid or expired or invalid and upon successful authentication, the RFID lock 20 is unlocked. In the fourth step, the RFID-to-Bluetooth selective adapter 10 is to automatically connect with the gateway device 30, or alternatively, the wireless mobile electronic device 1 can be made to connect with the gateway device 30. In the fifth step, the gateway device 30 is to control and power on the power control module 40 by passing along the administrator management privileges. In the sixth step, the wireless mobile electronic device 1 gains control of the gateway device 30 to power on the power control module 40. In the seventh step (part a), the detecting module 50 broadcasts interrogation signals under low-power to detect for presence of the wireless mobile electronic device 1 via the gateway device 30 acting as intermediary, and upon recognizing the wireless mobile electronic device 1, to then request the wireless mobile electronic device 1 to control and power off the power control module 40 via the gateway device 30 acting as intermediary; or alternatively (part b), the detecting module 50 can broadcast interrogation signals under low-power to the wireless mobile electronic device 1 via the gateway device 30, and upon recognizing the wireless mobile electronic device 1, the gateway device 30 directly power off the power control module 40. When the detecting module 50, through interrogation signals, recognizes that the occupant has vacated the room, the detecting module 50 would then instruct the power control module 40 to be powered off using the gateway device 30 to send a power off signal to the wireless mobile electronic device 1, which in turn controls the power control module 40 to power off. Meanwhile, if the gateway device 30 fails to receive a reply from the wireless mobile electronic device 1 within a specified amount of time, the occupant is then deemed to have vacated the room, such that the power control module 40 is instructed to be powered off. In the aforementioned short range space management automation and control method and the short range space management automation and control system of the another embodiment, the electrical appliances 60 include lamps, lights, air conditioning unit, heater, radio, stereo, television, wall outlet, power outlet, lighting intensity, HVAC settings, and television remote control settings, but are not limited to these examples.

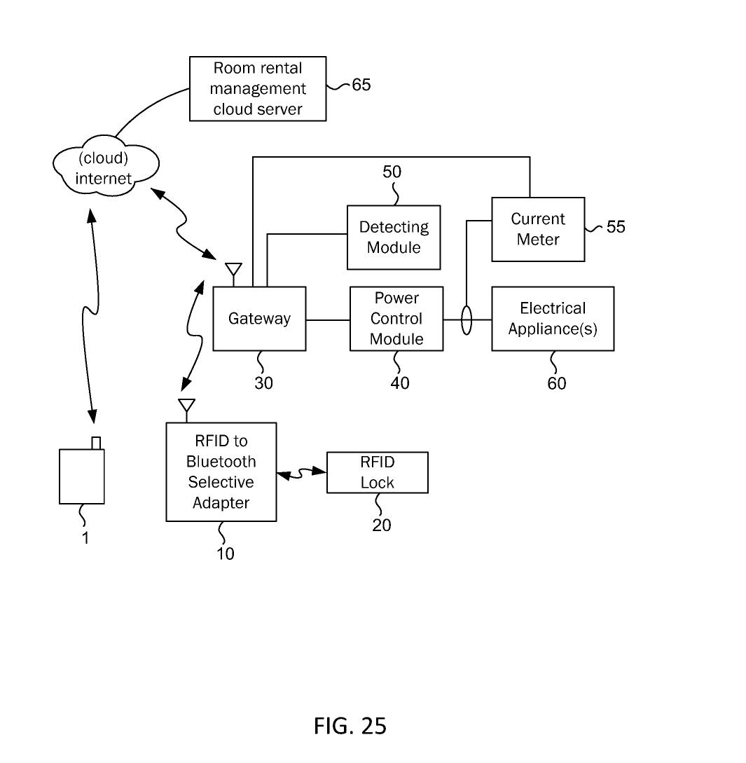

Referring to FIG. 25, a block diagram of a long-range room rental management system in accordance to a yet another embodiment of present invention is shown. In the illustrated embodiment, the long-range room rental management system includes a room rental management cloud server 65, a gateway device 30, a wireless mobile electronic device 1, such as a smartphone 1 or a wearable electronic device 1, one or more electrical appliances 60, a RFID-to-Bluetooth selective adapter 10, a RFID lock 20, a current meter 55, a detecting module 50 and a power control module 40. The room rental management cloud server 65 can be hosted at a secure server location and is connected to the internet. The gateway device 30 is coupled to the power control module 40 and the detecting module 50, respectively. The gateway device 30 is capable of maintaining two-way communication with the internet, and the RFID-to-Bluetooth selective adapter 10, respectively. The wireless mobile electronic device 1 is connected to the internet. The RFID-to-Bluetooth selective adapter 10 is installed at close proximity to the RFID lock 20. The RFID-to-bluetooth selective adapter 10 and the RFID lock 20 being in close proximity are able to establish two-way communications. The RFID lock 20 has a RFID reader therein. The RFID lock 20 can be the RFID reader equipped device (17) which are both described in U.S. application serial no. U.S. Ser. No. 14/623,464, which becomes U.S. Pat. No. 9,087,246. The long-range room rental management system of the illustrated embodiment operates with internet connection. The power control module 40 is coupled to the one or more electrical appliances 60, respectively, so as to allow provisioning of power thereof. The current meter 55 is configured to detect current readings of the power lines supplied to the one or more electrical appliances 60. A room renter can use the wireless mobile electronic device 1 to be connected via the internet to a designated webpage of the room rental company, which for example, can be a hotel, and upon pressing a button on the designated webpage to initiate a door opening command for a specified hotel room, the room rental management cloud server 65 sends a door opening command for the specified hotel room to the gateway device 30, the gateway device 30 sends the door opening command to the RFID-to-Bluetooth selective adapter 10 of the specified hotel room to unlock the RFID doorlock as well as power on the power control module 40 in the specified hotel room. In addition, the room renter can use the wireless mobile electronic device 1 to control the power control module 40. The electrical appliances 60 include lamps, lights, air conditioning unit, heater, radio, stereo, television, wall outlet, power outlet, lighting intensity, HVAC settings, and television remote control settings, which can be respectively controlled and configured via a plurality of personalized preference settings for the room renter based on historical data collected over time for the room renter at the hotel stored in the room rental management cloud server 65. The room renter can turn off power to the power control module 40 of the specified hotel room through the internet.

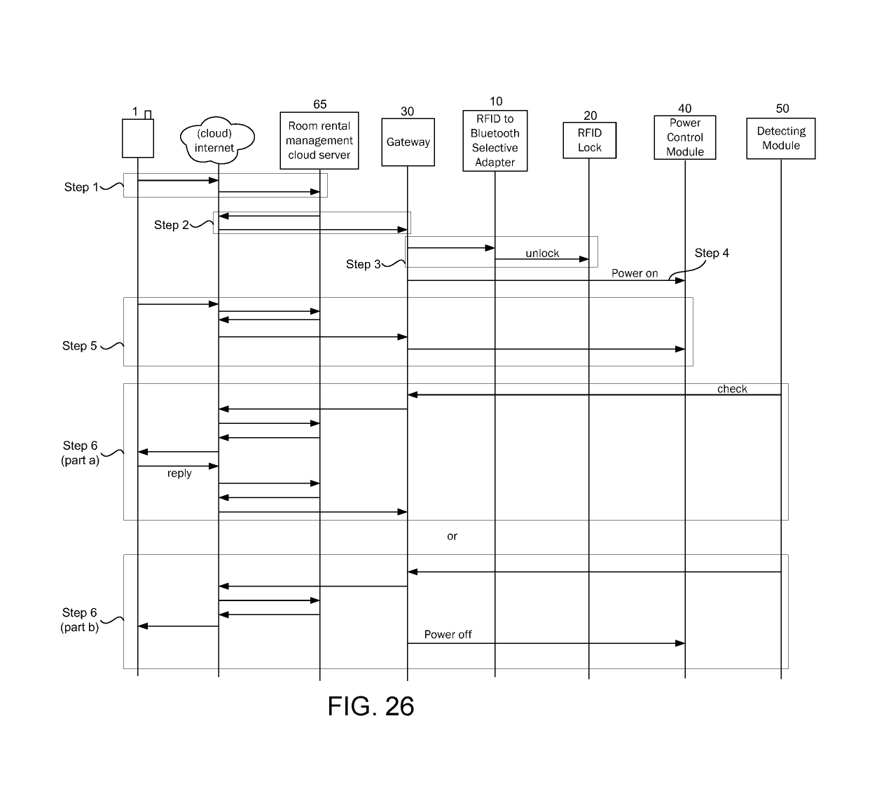

Referring to FIGS. 25 and 26, a simplified operation process flow schematic of a long range room rental management method of the yet another embodiment is described and shown, which includes the following steps: In the first step, a smartphone 1 initiates transmission to the internet to reach a room rental management cloud server 65. In the second step, upon authentication of the smartphone 1, the room rental management cloud server 65 contacts and controls a gateway device 30 located at a selected location. In the third step, the gateway device 30 contacts and controls a RFID-to-bluetooth selective adapter 10 to unlock an RFID lock 20, the gateway device 30 also contacts and controls a power control module 40 located at the selected location to be powered on. Later, in the fourth step, the gateway device 30 directly contacts and controls the power control module 40. In the fifth step, the smartphone 1 of the user/occupant uses the room rental management cloud server 65 to contact and control the power control module 40. The occupant is to perform authentication of identity thereof through the room rental management cloud server 65, so as to ensure that the power control module 40 is to be controlled and used by authenticated occupant only (as verified by the room rental management cloud server 65). The authenticated occupant can be for example, room renter for the occupied space of the selected location. In the sixth step, which is divided into two parts, namely a part a or a part b. In part a of the sixth step, the detecting module 50 broadcasts interrogation signals under low-power to detect for presence of the wireless mobile electronic device 1 or to detect as to whether if there is any moving object within the selected location, or through the gateway device 30 and the room rental management cloud server 65 acting as intermediary, to report back to the smartphone 1 occupancy status, i.e. room is empty, or that the room is occupied by people, so that the room occupant can use the smartphone 1 through the room rental management cloud server 65, together with the gateway device 30 acting as intermediary, to control the power control module 40, the subsequent steps are same as in the fifth step. Alternatively in part b of the sixth step, the detecting module 50 broadcasts interrogation signals under low-power to detect for presence of the wireless mobile electronic device 1 or to detect for presence of any moving object within the selected location, and through the gateway device 30 and the room rental management cloud server 65 acting as intermediary, vacancy status within the selected location is reported back to the smartphone 1, upon which the gateway device 30 directly issues power off command to the power control module 40, without using the smartphone 1. Advantage of this alternative embodiment is to offer more flexibility and adaptability to maintain continuous control and power on/off of the power control module 40 even when unable to receive any reporting signals from the room rental management cloud server 65 or when internet service has been interrupted or broken down. Meanwhile, if the gateway device 30 fails to receive a reply from the wireless mobile electronic device within a specified amount of time, the occupant is then deemed to have vacated the room, such that the power control module 40 is instructed to be powered off. In the aforementioned long-range room rental management method and the long-range room rental system, the electrical appliances 60 include lamps, lights, air conditioning unit, heater, radio, stereo, television, wall outlet, power outlet, lighting intensity, HVAC settings, and television remote control settings, but are not limited to these examples.

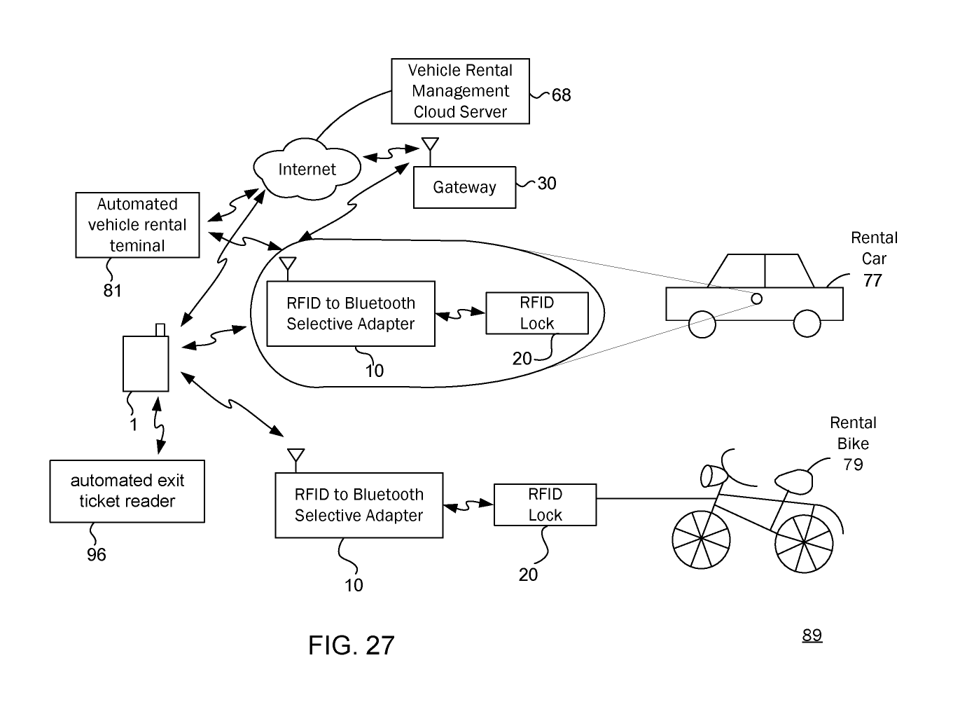

Referring to FIG. 27, a block diagram of a transportation vehicle rental management system 89 is shown. The transportation vehicle rental management system 89 of the illustrated embodiment includes a vehicle rental management cloud server 68, a gateway device 30, an automated vehicle rental terminal 81 a plurality of RFID-to-Bluetooth selective adapters 10, a plurality of RFID locks 20, and a plurality of rental vehicles 77. The rental vehicle 77 can be a car, a van, a minivan, an SUV, a motorcycle, a bicycle, a jet ski, but is not limited to these. The RFID lock 20 can be permanently fixed on the rental vehicle 77 itself. The RFID-to-Bluetooth selective adapter 10 can be configured together with the RFID lock 20 to be installed on the rental vehicle 77, such as a rental automobile. However, the RFID-to-Bluetooth selective adapter 10 can also be configured in a stand-alone or portable manner, and the RFID lock 20 can be installed by itself on a rental bicycle 79. The gateway device 30 provides secure two-way wireless data transmission between the RFID-to-Bluetooth selective adapter 10 and the vehicle rental management cloud server 68 via the internet. The automated vehicle rental terminal 81 being connected to the internet is configured to communicate and interact with the RFID-to-Bluetooth selective adapters 10. In the illustrated embodiment, the RFID-to-Bluetooth selective adapter 10 configured together with the RFID lock 20 can be installed next to a car door lock on a rental vehicle 77, and through authentication of the digital certificate acting as an electronic key, the car door lock can then be opened and closed. In addition, the aforementioned digital certificate can also serve as the ignition key to start or stop an engine of the rental vehicle 77. As a result, the car door lock becomes a more secured built-in component, thereby preventing criminals/thieves from tempering with the car door lock key hole by increasing the degree of difficulty of lock picking. Using the more diversified perimeter access control methods and the transportation vehicle rental management system 89 of present application, the vehicle rental companies are no longer required to physically hand off or drop off a physical car key to the vehicle renter, while instead, transmit the electronic key in the form of a digital certificate via the internet in a wireless manner to the smartphone 1 or the mobile electronic device 1 belonging to the vehicle renter, as well as notifying the vehicle renter as to the pick-up location of the rental vehicle 77. Upon arriving at the rental vehicle 77, the vehicle renter can conveniently open the car door as well as activate the ignition switch of the rental vehicle 77 for easy drive off of the rental vehicle 77 to a desired destination.

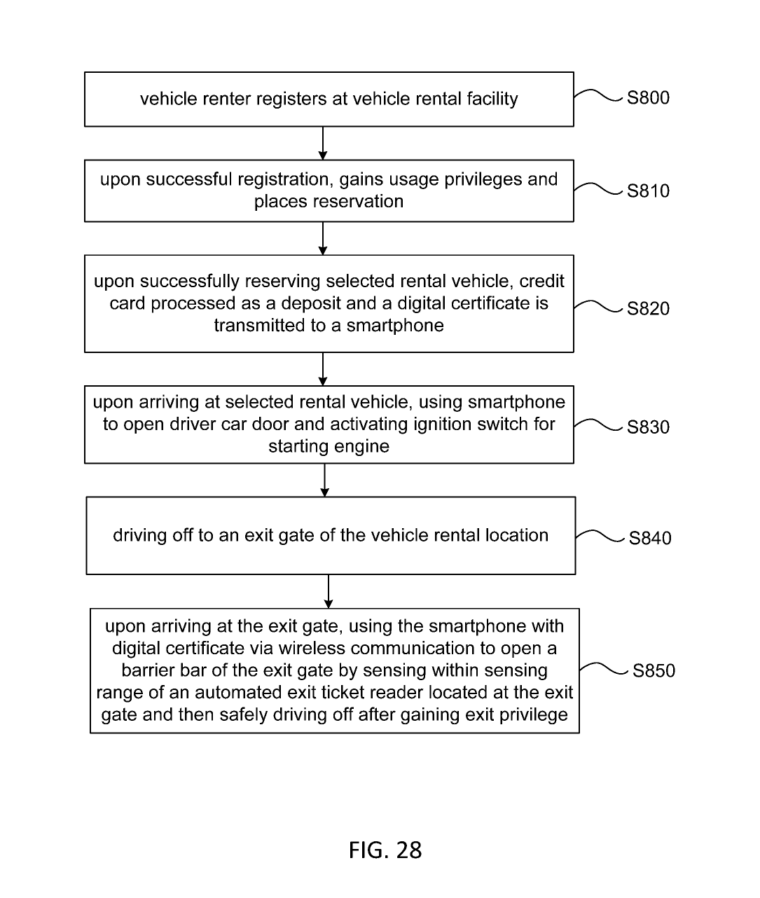

Referring to a flow chart diagram as shown in FIG. 28, a transportation vehicle rental management method is shown, which includes the following steps. Step S800: a vehicle renter registers either using a web portal online or a rental station kiosk located at a specified vehicle rental facility or location and typing in various requested registration information; Step S810: upon successful registration of the vehicle renter, the vehicle renter than gains full range of usage privileges of the transportation vehicle rental management system 89, whereby the vehicle renter places a reservation for a rental order of a selected rental vehicle 77 at the specified vehicle rental location. Step S820: upon successfully completing of reserving the selected rental vehicle 77 and placing the rental order for the selected rental vehicle 77 at the specified rental location, credit card processing is performed for serving as a deposit for a rental contract for the rental order, and a digital certificate (used as an electronic key) is generated and transmitted via the internet wirelessly to a smartphone 1 (or a mobile electronic device) belonging to the vehicle renter, as well as notifying the vehicle renter as to the pick-up location of the selected rental vehicle 77. Step S830: upon arriving at the selected rental vehicle 77, the vehicle renter uses the smartphone 1 to communicate directly with a smart door lock on the selected renter vehicle 77, the smart door lock of the selected renter vehicle includes a RFID-to-Bluetooth selective adapter 10 configured together with a RFID lock 20 installed in a driver car door, so as to gain authorization and usage privileges upon authentication to unlock the RFID lock 20 and open the driver car door along with activating an ignition switch of the rental vehicle (thus starting the engine) using an another RFID-to-Bluetooth selective adapter 10 configured together with an another RFID lock 20 located at close proximity to a steering column of the selected rental vehicle 77. Step S840: the vehicle renter then driving off the rental vehicle to an exit gate 90 of the vehicle rental location. Step S850: upon arriving at the exit gate 90, the vehicle renter can use the smartphone 1 with the digital certificate via wireless communication to open a barrier bar 95 of the exit gate 90 of the vehicle rental location, by bringing the smartphone 1 within sensing range of an automated ticket reader 96 located at the exit gate 90 and then safely driving off after gaining exit privilege or permission.

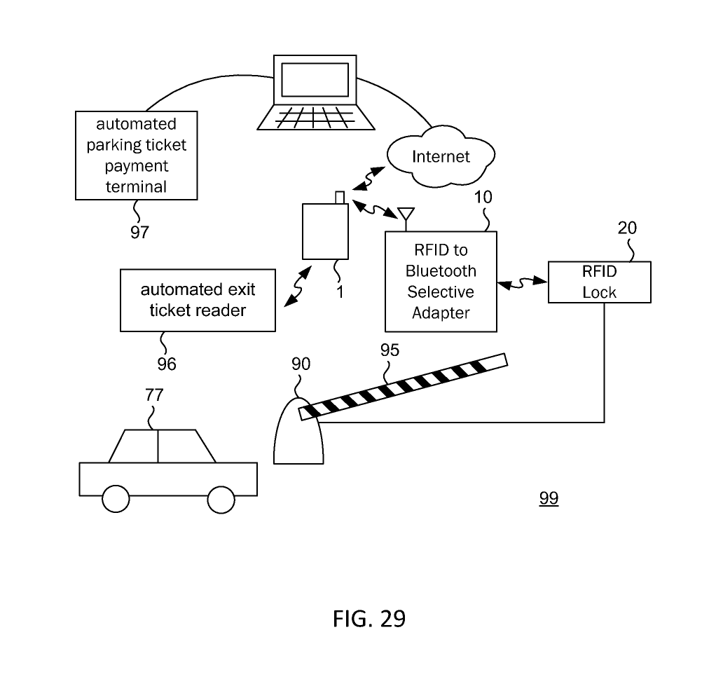

Referring to FIG. 29, an automated vehicle parking lot management system 99 is shown in a simplified conceptual schematic according to an illustrative example of the embodiment of present application. The automated vehicle parking lot management system includes a smartphone 1, an automated parking ticket payment terminal 97, an automated exit gate 90 comprising a barrier bar 95, and an automated exit ticket reader 96. The automated exit ticket reader 96 is located adjacent to the automated exit gate 90 and is configured with a RFID-to-Bluetooth selective adapter 10 and a RFID lock 20 installed therein. The barrier bar 95 of the automated exit gate 90 is lowered for obstructing vehicle passage and raised for releasing vehicle passage.

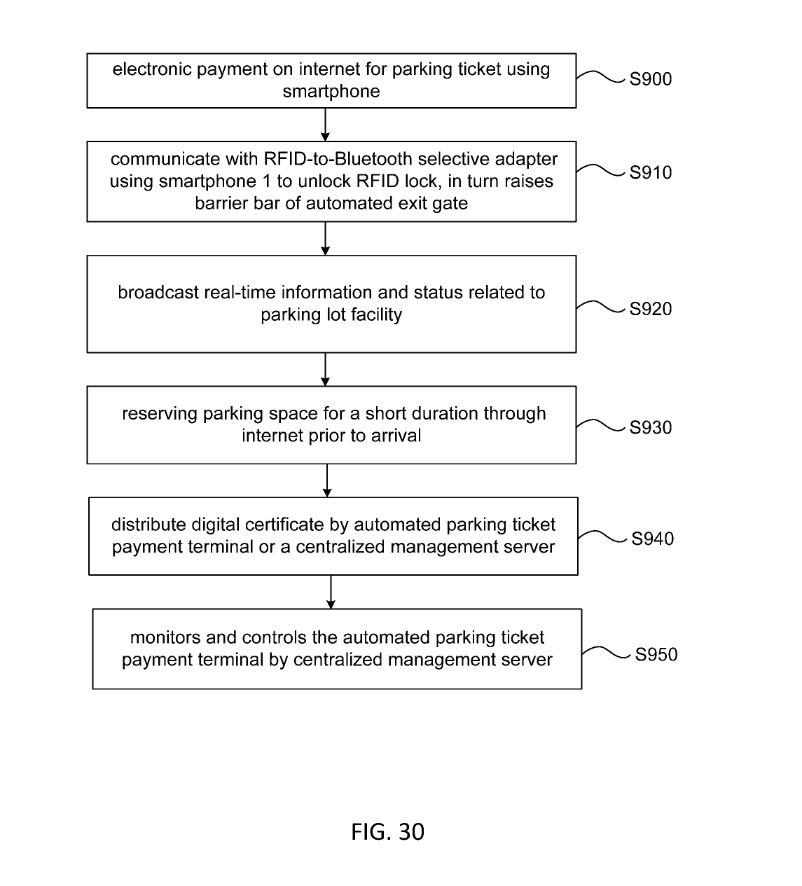

Referring to FIG. 30, a flow chart of an automated vehicle parking lot management method for the automated vehicle parking lot management system 99 is shown, which include the following steps, but do not have to be in sequential order: Step S900: a parking customer can perform electronic payment on the internet using an APP or login on a web portal for a parking ticket at a parking lot facility using a smartphone 1. Step S910: upon completion of performing electronic payment on the internet for the parking ticket, the parking customer can communicate with the RFID-to-Bluetooth selective adapter 10 using the smartphone 1 to unlock the RFID lock 20, which in turn raises the barrier bar 95 of the automated exit gate 90 to allow exit of the vehicle. Step S920: Real-time information and status related to the parking lot facility can be broadcasted and provided to a parking customer through internet access. Step S930: A parking space at the parking lot facility can be reserved by the parking customer for a short duration through internet prior to arrival thereof at the parking lot facility. Step S940: A digital certificate can be distributed by the automated parking ticket payment terminal 97 or a centralized management server (not shown), in which the digital certificate serves the same function and purpose as a conventional paid parking token or RFID parking ticket, so as to permitting the parking customer to exit out of the vehicle parking lot using the digital certificate. The digital certificate can be a one-time digital certificate, or periodical digital certificate. Step S950: The centralized management server monitors and controls the automated parking ticket payment terminal 97 through a network connection.

In the above embodiments, the APP is configured to provide wireless access management and control of the RFID lock 20 using the RFID-to-Bluetooth selective adapter 10 via BLE communications, and to provide with a user account for the user on the smartphone 1 to register the RFID-to-Bluetooth selective adapter 10 as an authenticated trusted device in a cloud based authentication server. In addition, the APP is used to set up access permissions for the authenticated RFID-to-Bluetooth selective adapter 10, and transferring the digital certificate issued from the cloud based authentication server to the RFID-to-Bluetooth selective adapter 10. The user can use the APP to activate or deactivate the RFID lock 20 using the RFID-to-Bluetooth selective adapter 10 in real-time conveniently with or without internet connection. In a RFID doorlock usage scenario, the user can use the APP to open or close a door with a RFID smart doorlock mounted with a RFID-to-Bluetooth selective adapter 10 in real-time conveniently with or without internet connection.

In the above embodiments, the compatible Bluetooth versions that can be used include Bluetooth, Bluetooth smart, Bluetooth smart ready, and/or other Bluetooth versions also included. Bluetooth as mentioned in the present disclosure is one example of communication protocol and authentication medium, therefore, other wireless authentication and communication protocols can be equally effective to be adapted for full utilizations in accordance with embodiments of present invention. The present disclosure offers flexibility in selecting different types of authentication and communication protocol and medium to actuate an RFLID chip so as to open an RFID lock 20, such as door lock.

Other alternative security options can be adopted for authentication and verification of the user, such as light, sound, and key-in passwords. Using the illuminating light variations of the smartphone 1, the RFID-to-Bluetooth selective adapter 10 can sense and detect to perform authentication. Using a sequence of sounds, the RFID-to-Bluetooth selective adapter 10 can also detect for matching a set of authentication sound sequence. Using key-in of the passwords on a set of numerical keypads disposed on the RFID lock 20 or the RFID-to-Bluetooth selective adapter 10, authentication and verification of the user can also be provided.

In the above embodiments, the gateway device 30 can be a conventional commercially available gateway device from Cisco Systems or Huawei, such as for example, Huawei model number HG630b home gateway. The detecting module 50 can be LUTRON LOS C Series Occupancy Sensor, such as for example. In the above embodiments, the current meter 55 has been described in the U.S. application Ser. No. 14/726,584.

In the above embodiments, the RFID-to-Bluetooth selective adapter is described and illustrated in detail as one example of the selective adapter in accordance to present invention. However, another examples for the selective adapter 10 can be also provided such as, a WIFI-to-NFC selective adapter, or a 4G-to-RFID selective adapter, just to name a few. The wireless communication conversion unit belonging as part of the selective adapter enables the selective adapter to be able to be adapted to various different wireless communication platforms, so as to be not just limited to RFID and Bluetooth.

In the above embodiments, the terms “activated” and “activating” can have at least one of the following meanings: (a) for an entity to go from an “on” state to an “off” state when it is currently in an “off” state; or (b) for an entity to go from an “off” state to an “on” state when it is currently in an “on” state; (c) for a circuit to go from a closed circuit to an open circuit when it is currently in closed circuit state; or (d) for a circuit to go from an open circuit to an closed circuit when it is currently in open circuit state. Entity can be any of the component elements of the RFID-to-Bluetooth selective adapter. Circuit can be a circuit of one entity. The terms “activating” and “activate” are different from the terms “initiating” and “initiate”, because “activating” and “activate” implies that the entity subsequently may continue on to perform authorized actions, whereas, “initiating” and “initiate” merely implies that the entity has being powered on, without being given any authentication or permissions for performing further actions.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An integrated perimeter access control system, comprising:
a smartphone;
a selective adapter;
one or more second wireless communication tags, and
a second wireless communication controlling lock comprising a second wireless communication reader therein,
wherein the selective adapter is configured for receiving a wireless transmission signal and operating under a first wireless communication platform and a second wireless communication platform, and is installed above a sensor area of the second wireless communication controlling lock to facilitate the second wireless communication reader in the second wireless communication controlling lock to interrogate the selective adapter, the wireless transmission signal is transmitted under the first wireless communication platform, the first wireless communication platform is different from the second wireless communication platform, the wireless communication conversion unit selectively determines whether to allow transmission of the wireless transmission signal after performing a digital certificate authentication procedure based on the wireless transmission signal.

2. The integrated perimeter access control system of claim 1, wherein the selective adapter is a wireless communication conversion unit, the wireless communication unit comprising:
a first wireless system on chip (SoC);
a second wireless system on chip (SoC); and
an on/off switch;
wherein the first wireless SoC is coupled to the on/off switch, the on/off switch is coupled to the second wireless SoC, the first wireless SoC turn on the second wireless SoC using the on/off switch, the first wireless SoC selectively determine whether to allow the second wireless SoC to transmit the wireless transmission signal after performing the digital certificate authentication procedure.

3. The integrated perimeter access control system of claim 2, wherein the first wireless SoC is a BLE SoC and the second wireless SoC is a RFID chip for the wireless communication conversion unit.

4. The integrated perimeter access control system of claim 1, wherein the first wireless communication platform and the second wireless communication platform are selected from the group consisting of WIFI, BLE, Bluetooth, 3G, 4G, NFC, RFID, GSM, ANT, LTE, UWB, and Zigbee, respectively.

5. The integrated perimeter access control system of claim 1, wherein the selective adapter comprising a RFID sensor coil therein, while the selective adapter operating under a deactivated state, the RFID sensor coil is under an open circuit, and the second wireless communication controlling lock is interrogating the one or more second wireless communication tags without interference by the selective adapter.

6. The integrated perimeter access control system of claim 1, wherein the selective adapter is turned on in a contactless manner using the smartphone and an app, the smartphone has a camera light source, and the app is installed in the smartphone and is configured for interacting with the selective adapter, the selective adapter has a photo sensor unit thereon.

7. The integrated perimeter access control system of claim 6, wherein the photo sensor unit comprising a first photosensitive circuit, a second photosensitive circuit or a third photosensitive circuit, the first photosensitive circuit has a photodiode, the second photosensitive circuit has a photo resistor, and the third photosensitive circuit has an amorphous silicon solar cell, an incident light from the camera light source of the smartphone is illuminated on the photo sensor unit to power on the selective adapter in a contactless manner.

8. The integrated perimeter access control system of claim 1, wherein the second wireless communication controlling lock is configured with a low-power infrared proximity sensor and the selective adapter comprising a low-power infrared proximity sensing circuit, comprising an infrared transmitter and receiver unit and a voltage comparator, a reflected signal is simulated by the infrared transmitter and receiver unit and transmitted to the low-power infrared proximity sensor of the second wireless communication controlling lock, the low-power infrared proximity sensor of the second wireless communication controlling lock receives the reflected signal from the infrared transmitter and receiver unit, the reflected signal is reverted to become a switching on/off signal using the voltage comparator, and transmitted to the low-power infrared proximity sensor of the second wireless communication controlling lock from the infrared transmitter and receiver unit.

9. The integrated perimeter access control system of claim 8, wherein the infrared transmitter and receiver unit remains under dormant mode under normal operation.

10. The integrated perimeter access control system of claim 1, wherein the second wireless communication controlling lock is configured with a low-power capacitive proximity sensor and a metal housing, and the selective adapter comprising a low-power capacitive proximity sensing circuit comprising a metal plate adhered to the sensor area, so that upon activating the selective adapter to initiate opening of the second wireless communication controlling lock, the metal plate is made to be conducting to the metal housing of the second wireless communication controlling lock and thereby actuating the low-power capacitive proximity sensor of the second wireless communication controlling lock.

11. The integrated perimeter access control system of claim 8, wherein when the selective adapter is opening the second wireless communication controlling lock, the voltage comparator circuit is then initiated, and the infrared transmitter and receiver unit is then triggered into action to conduct RFID coil actuation of the second wireless communication controlling lock.

12. The integrated perimeter access control system of claim 1, wherein electronic payment processing is performed through authentication of a digital certificate in the digital certificate authentication procedure, the digital certificate is issued from an automated payment terminal or a centralized management server using the smartphone via internet configured under the first wireless communication platform or the second wireless communication platform.

13. The integrated perimeter access control system of claim 1, wherein the selector adapter is a RFID-to-Bluetooth selective adapter, the one or more second wireless communication tags is one or more RFID tags, the second wireless communication controlling lock is a RFID lock, the second wireless communication reader is a RFID reader, the RFID-to-Bluetooth selective adapter is installed above a sensor area of the RFID lock to facilitate the RFID Reader in the RFID lock to interrogate the RFID-to-Bluetooth selective adapter.

14. The integrated perimeter access control system of claim 1, wherein the smartphone operating under the first wireless communication platform, performs authentication of the selective adapter to control and open the second wireless communication controlling lock.

15. A selective adapter adapted for use together with an electronic lock having a second wireless communication reader therein and a sensor area thereon, comprising:
a wireless communication conversion unit, comprising:
an on/off switch;
a first wireless system on chip (SoC);
a second wireless system on chip (SoC); and
wherein the wireless communication conversion unit is configured for receiving a wireless transmission signal and operating under a first wireless communication platform and a second wireless communication platform, the first wireless communication platform is different from the second wireless communication platform, the first wireless SoC is coupled to the on/off switch, the on/off switch is coupled to the second wireless SoC, the first wireless SoC turns on the second wireless SoC using the on/off switch, the first wireless SoC selectively determines whether to allow the second wireless SoC to transmit the wireless transmission signal after performing a digital certificate authentication procedure, the selective adapter is installed above the sensor area of the electronic lock to facilitate interrogation thereof by the second wireless communication reader in the electronic lock.

16. The RFID-to-Bluetooth selective adapter of claim 15, wherein the Bluetooth module is operating under Bluetooth, Bluetooth smart, or Bluetooth smart ready protocol.

17. The RFID-to-Bluetooth selective adapter of claim 15, wherein the first wireless communication platform is different from the second wireless communication platform, and are selected from the group consisting of WIFI, BLE, Bluetooth, 3G, 4G, NFC, RFID, GSM, ANT, LTE, UWB, and Zigbee, respectively.
